(19) United States
(12) Patent Application Publication
(10) Pub. No.: US 2024/0155334 A1
(43) Pub. Date: May 9, 2024

(54) Method and Apparatus for Exposing User Equipment Address Information

(71) Applicant: Telefonaktiebolaget LM Ericsson (publ), Stockholm (SE)

(72) Inventor: Qiang Liu, Shanghai (CN)

(21) Appl. No.: 18/550,526

(22) PCT Filed: Mar. 21, 2022
(86) PCT No.: PCT/CN2022/082024

§ 371 Date: Sep. 14, 2023

(30) Foreign Application Priority Data
Mar. 22, 2021 (WO) PCT/CN2021/082115

(51) Int. Cl. H04W 8/26; H04L 61/00

(52) U.S. Cl. CPC H04W 8/26; H04L 61/35

(57) ABSTRACT

Embodiments of the present disclosure provide method and apparatus for exposing user equipment address information. A method performed by a method comprises receiving a first subscribe request for subscribing existing user equipment (UE) address information and/or UE address change information related to a network from an application function. The method further comprises obtaining the existing UE address information and/or UE address change information related to the network based on the first subscribe request. The method further comprises sending the existing UE address information and/or UE address change information related to the network to the application function.

### TECHNICAL FIELD

The non-limiting and exemplary embodiments of the present disclosure generally relate to the technical field of communications, and specifically to methods and apparatuses for exposing user equipment address information.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example LTE (Long Term Evolution) and NR (new radio) as defined by 3rd Generation Partnership Project (3GPP), the communication networks may provide connectivity between a UE (user equipment) and a data network (DN).

Clause 5.10.2 of 3GPP TS 23.401 V16.9.0, the disclosure of which is incorporated by reference herein in its entirety, describes UE requested PDN (Packet Data Network) connectivity procedure. The procedure allows the UE to request for connectivity to an additional PDN over E-UTRAN (Evolved Universal Terrestrial Radio Access Network) including allocation of a default bearer, if the UE already has active PDN connections over E-UTRAN. This procedure may also be used when a UE has set “Attach without PDN Connectivity is supported” in the Preferred Network behavior at attach time and the network has acknowledged its support to the UE. If so, the UE may remain attached without a Default PDN connection and, at any time, request a PDN connection to be established. This procedure is also used to request for connectivity to an additional PDN over E-UTRAN, if the UE is simultaneously connected to E-UTRAN and a non-3GPP access and the UE already has active PDN connections over both accesses. The PDN connectivity procedure may trigger one or multiple Dedicated Bearer Establishment procedures to establish dedicated EPS (Evolved Packet System) bearer(s) for that UE. The PDN type may comprise IPv4 (IP (Internet protocol) version 4) or IPv6 (IP version 6) or “Non-IP” or “Ethernet”. The IP (Internet protocol) address allocation details are described in clause 5.3.1 on “IP Address Allocation” of 3GPP TS 23.401 V16.9.0. Support of PDN type Ethernet is described in clause 4.3.17.8a of 3GPP TS 23.401 V16.9.0.

In fifth generation (5G) communication network, it may provide 5G LAN (Local Area Network) type service. The 5G LAN type service may be a service over the 5G system offering private communication using IP and/or non-IP type communications. A 5G LAN-Virtual Network (VN) may be a virtual network over the 5G system capable of supporting 5G LAN-type service. A 5G VN group may comprise a set of UEs using private communication for 5G LAN-type service.

As described in clause 5.29.2 of 3GPP TS 23.501 V16.7.0, the disclosure of which is incorporated by reference herein in its entirety, a 5G VN group may be characterized by the following:
5G VN group identities (ID): External Group ID and Internal Group ID are used to identify the 5G VN group.
5G VN group membership: The 5G VN group members are uniquely identified by GPSI (Generic Public Subscription Identifier). The group as described in clause 5.2.3.3.1 of 3GPP TS 23.502 V16.7.1, the disclosure of which is incorporated by reference herein in its entirety, is applicable to 5G LAN-type services.
5G VN group data: The 5G VN group data may include the following parameters: PDU (Protocol Data Unit) session type, DNN (Data Network Name), S-NSSAI (Single Network Slice Selection Assistance Information) and Application descriptor, Information related with secondary authentication/authorization (e.g. to enable IP address assignment by the DN-AAA (authentication, authorization and accounting)).

As per clause 6.26.2.5 of 3GPP TS 22.261 V18.1.1, 5G LAN type service may have different types of traffic:
traffic scenarios typically found in a home setting (from sensors to video streaming, relatively low amount of UEs per group, many devices are used only occasionally) for 5G LAN-type service.
traffic scenarios typically found in an office setting (from sensors to very high data rates e.g. for conferencing, medium amount of UEs per group) for 5G LAN-type service.
traffic scenarios typically found in an industrial setting (from sensors to remote control, large amount of UEs per group) for 5G LAN-type service.

As per clause 5.29.4 of 3GPP TS 23.501 V16.7.0, there are three types of traffic forwarding methods allowed for 5G VN communication:
N6-based, where the UL/DL (uplink/downlink) traffic for the 5G VN communication is forwarded to/from the DN;
N19-based, where the UL/DL traffic for the 5G VN group communication is forwarded between PSA (PDU Session Anchor) UPFs (User Plane Function) of different PDU sessions via N19. N19 is based on a shared User Plane tunnel connecting PSA UPFs of a single 5G VN group;
Local switch, where traffic is locally forwarded by a single UPF if this UPF is the common PSA UPF of different PDU Sessions for the same 5G VN group.

FIG. 1 shows a local-switch based user plane architecture in non-roaming scenario. FIG. 1 is same as FIG. 4.4.6.1-1 of 3GPP TS 23.501 V16.7.0. FIG. 2 shows an N19-based user plane architecture in non-roaming scenario. FIG. 2 is same as FIG. 4.4.6.1-2 of 3GPP TS 23.501 V16.7.0. FIG. 1 and FIG. 2 show user plane architectures to support 5G LAN type services. For UEs within the same region, the local-switch based architecture may be used to provider better Quality of Experience (QoE), together with N19 based architecture for communication with UEs in other regions. I-UPF denotes Intermediate UPF. R(AN) denotes (Radio) Access Network. As described in 3GPP TS 23.501 V16.7.0, N19 is a reference point between two UPFs for direct routing of traffic between different PDU Sessions without using N6. N3 is a reference point between the (R)AN and the UPF. N9 is a reference point between two UPFs.

IPv6 Multi-Homing for a PDU Session

An IP type PDU Session may be associated with multiple IPv6 prefixes (therefore multiple IPv6 addresses). This is referred to as multi-homed PDU Session. The multi-homed PDU Session provides access to the Data Network via more than one PDU Session Anchor.

When a PCC (Policy and Charging Control) rule including the AF influenced Traffic Steering Enforcement Control information as defined in clause 6.3.1 of 3GPP TS 23.503 V16.7.0, the disclosure of which is incorporated by reference herein in its entirety, is provided to the SMF (Session Management Function), the SMF can decide whether to apply traffic routing (by using UL Classifier functionality or IPv6 multi-homing) based on DNAI(s) (DN Access Identifier) included in the PCC rule. AF influenced Traffic Steering Enforcement Control information can be either determined by the PCF (Policy Control Function) when requested by AF via NEF (Network Exposure Function) or statically pre-configured in the PCF.

FIG. 3 shows a scenario of Multi-homed PDU session of local access to same DN. FIG. 3 is same as FIG. 5.6.4.3-2 of 3GPP TS 23.501 V16.7.0. The multi-homed PDU Session may also be used to support cases where UE needs to access both a local service (e.g. local server) and a central service (e.g. the Internet). The UE shall use the method specified in clause 4.3.5.3 of 3GPP TS 23.502 V16.7.1 to determine if a multi-homed PDU Session is used to support the local access to DN case. AMF denotes Access and Mobility Management Function. AN denotes Access Network. As described in 3GPP TS 23.501 V16.7.0, N1 is a reference point between the UE and the AMF. N2 is a reference point between the (R)AN and the AMF. N4 is a reference point between the SMF and the UPF. N11 is a reference point between the AMF and the SMF. N9 is a reference point between two UPFs. N6 is a reference point between the UPF and a Data Network.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Ethernet Type PDU Session in 5G Network

5G network supports Ethernet type PDU session. The typical use cases of Ethernet type PDU session in 5G network includes (but not limited to) the 5G LAN type services, TSN (Time Sensitive Networking), etc.

FIG. 4 shows a scenario of multiple Ethernet devices behind UE in 5G LAN type service. There could have multiple Ethernet type devices connecting to UE 1 and communicating via UE 1 with UE 2 or multiple Ethernet type devices behind UE 2, by using Ethernet type PDU session and 5G LAN type service, as shown in FIG. 4. An Ethernet type device may be involved in 5G LAN VN at runtime, e.g. device 2 as a new device can connect to UE 1 and join this 5G LAN VN dynamically, while device 1 may be powered off at some time and disconnect from this 5G LAN VN.

As per 3GPP TS 23.502 V16.7.1, for Ethernet PDU Session Type, neither a MAC (Medium Access Control) nor an IP address is allocated by the SMF to the UE for this PDU Session.

An application function (AF) may update the UE identities of the 5G VN group at any time after the initial provisioning.

The PDU session type, DNN, S-NSSAI provided within 5G VN group data cannot be modified after the initial provisioning.

As per 3GPP TS 23.501 V16.7.0, a home network of the 5G VN group members is same.

As per 3GPP TS 23.501 V16.7.0, only a 1:1 mapping between (DNN, S-NSSAI) combination and 5G VN group is supported.

As per 3GPP TS 23.501 V16.7.0, A UE gets access to 5G LAN-type services via a PDU Session of IP PDU Session type or Ethernet PDU Session type. A PDU Session provides access to one and only one 5G VN group. The PDU Sessions accessing to a certain 5G VN group should all anchor at the same network, i.e., the common home network of 5G VN group members. A dedicated SMF is responsible for all the PDU Sessions for communication of a certain 5G VN group.

The user equipment address information may be used for various purposes. For example, an Application Function (AF) on behalf of network management organizations or administrators of DN or 5G LAN VN may need to know:
The UE addresses information of a network such as DN or 5G LAN VN (representing the entities involved in DN or 5G LAN VN communication);
The relationship between UE address(es) and UE ID (representing the topology information);
The change (e.g., new address, removed/obsoleted address) of UE address information.

For Mobile Network Operator (MNO), the user equipment address information may be used as input for traffic and/or charging policy decision for a network (such as DN or 5G LAN VN) for various use cases such as enterprise or home use cases, e.g. to limit the number of Ethernet devices connected to one UE, or to limit the total number of Ethernet devices in a network (such as DN or 5G LAN VN), or have different charging rate depending on the number of connected UEs and/or devices, etc.

For a network (such as DN or 5G LAN VN) administrator of an enterprise using the network (such as DN or 5GL LAN VN) service, the user equipment address information may be used as input for network (such as DN or VN) usage operation and maintenance. The user equipment address information may be used as input of data analytic for network (such as DN or VN) usage optimization.

For Application Functions, the user equipment address information may be used as indication if a UE is still in use. The user equipment address and/or address change information may be used as trigger for further actions at Application Function (AF) side. For example, as described in 3GPP TS 29.122 V17.0.0, the disclosure of which is incorporated by reference herein in its entirety, an AF can use the AsSessionWithQoS (Quality of Service) API (Application Programming Interface) to set up the required QoS for Service Data Flows (SDFs) of an IP or Ethernet type PDU session of a UE. However, UE address of this PDU session may change at runtime, and AF may need this UE address and/or address change information to perform further actions. For example, a UE uses an Ethernet type PDU session to connect to a 5G LAN VN. Multiple Ethernet type devices may connect to this UE for 5G LAN VN type service. At a time an Ethernet type device attached to this UE is powered on and starts communication with other entities in the 5G LAN VN, and the AF may need to take some actions based on this information, e.g. setup specific QoS for the SDFs related to this new device. When a new UE IPv6 address is allocated or removed, and the AF may need to take some actions based on this information, e.g. setup specific QoS for the SDFs related to the new IP address.

It has unique value for MNO to expose such UE address information to AF from network exposure point of view:
Unified interface: applicable for all types of UEs. AF does not need to interwork with different management software from different UE vendors
One access endpoint: AF may get UE address information via an exposure function such as NEF or SCEF (Service Capability Exposure Function)
Low entry cost: AF may get UE address information by using existing network exposure framework and via a simple API.

However, solutions of following issues are not proposed yet from E2E (End-to-End) point of view. For example, how AF gets the UE address (change) information of a network (such as DN or 5G LAN VN) via network exposure (e.g., NEF). How an exposure function (e.g., NEF) gets the UE address (change) information of a network (such as DN or 5G LAN VN) from other network function (NF) (such as 5GC (5G core network) NFs).

Though UE address information may be fetched from a management software on a UE. it is a UE vendor specific solution and may introduce complexities if UEs come from different vendors.

Therefore, it is necessary to propose new methods of exposing UE address (change) information of a network (such as DN or 5G LAN VN) via an exposure function such as NEF or SCEF, to facilitate a device such as AF to monitor UE address (change) information of the network (such as DN or 5G LAN VN) for various purposes.

In a first aspect of the disclosure, there is provided a method performed by an exposure function. The method comprises receiving a first subscribe request for subscribing existing user equipment (UE) address information and/or UE address change information related to a network from an application function. The method further comprises obtaining the existing UE address information and/or UE address change information related to the network based on the first subscribe request. The method further comprises sending the existing UE address information and/or UE address change information related to the network to the application function.

In an embodiment, the existing UE address information and/or UE address change information related to the network comprises at least one of the existing UE address information and/or UE address change information of the network, the existing UE address information and/or UE address change information of a UE of the network, the existing UE address information and/or UE address change information of a session of the network, or the existing UE address information and/or UE address change information of a group of UEs of the network.

In an embodiment, the network comprises at least one of a local area network (LAN) virtual network, or a data network.

In an embodiment, an address of a UE comprises at least one of an Internet Protocol (IP) address used by the UE, a Medium Access Control (MAC) address used by the UE, an IP address used by at least one device connected to the UE, or a MAC address used by at least one device connected to the UE.

In an embodiment, the first subscribe request comprises an identifier of the network.

In an embodiment, the first subscribe request comprises an identifier of the network and a UE identifier.

In an embodiment, the first subscribe request comprises an identifier of the network and an address of a UE.

In an embodiment, the first subscribe request comprises an identifier of the network and a group identifier.

In an embodiment, the first subscribe request comprises at least one of single network slice selection assistance information (S-NSSAI), an indication of UE MAC address change event to be subscribed, an indication of UE IP address change event to be subscribed, an indication of whether existing UE address information shall be returned, a uniform resource identifier (URI) of a notification endpoint, reporting control information, a reporting filter.

In an embodiment, the reporting control information comprises periodic reporting interval.

In an embodiment, the reporting filter comprises at least one of a UE address change type, an IP range, an MAC range, or a UE identifier range.

In an embodiment, the UE address change type comprises at least one of a type of new UE address, a type of obsoleted UE address, or a type of existing UE address.

In an embodiment, the method further comprises receiving a subscribe update request for updating a subscription created by the first subscribe request from the application function.

In an embodiment, the method further comprises sending a subscribe update response to the application function.

In an embodiment, the method further comprises receiving an unsubscribe request for deleting a subscription created by the first subscribe request from the application function.

In an embodiment, the method further comprises sending an unsubscribe response to the application function.

In an embodiment, the existing UE address information is sent in a first subscribe response or at least one UE address notification message.

In an embodiment, the UE address change information is sent in at least one UE address notification message.

In an embodiment, obtaining the existing UE address information and/or UE address change information related to the network based on the first subscribe request comprises sending a second subscribe request for subscribing the UE address information and/or UE address change information related to the network to a first network function, and receiving the existing UE address information and/or UE address change information from the first network function.

In an embodiment, the method further comprises sending a subscribe update request for updating a subscription created by the second subscribe request to the first network function.

In an embodiment, the method further comprises receiving a subscribe update response from the first network function.

In an embodiment, the method further comprises sending an unsubscribe request for deleting a subscription created by the second subscribe request to the first network function.

In an embodiment, the method further comprises receiving an unsubscribe response from the first network function.

In an embodiment, the second subscribe request comprises an identifier of the network.

In an embodiment, the second subscribe request comprises an identifier of the network and a UE identifier.

In an embodiment, the second subscribe request comprises an identifier of the network and an address of a UE.

In an embodiment, the second subscribe request comprises an identifier of the network and a group identifier.

In an embodiment, the second subscribe request comprises at least one of single network slice selection assistance information (S-NSSAI), an indication of UE MAC address change event to be subscribed, an indication of UE IP address change event to be subscribed, an indication of whether existing UE address information shall be returned, a uniform resource identifier (URI) of a notification endpoint, reporting control information, a reporting filter.

In an embodiment, the existing UE address information is received in a second subscribe response or at least one event exposure notification message.

In an embodiment, the UE address change information is received in an event exposure notification message.

In an embodiment, the network function comprises at least one of a session management function, a binding support function, or a policy control function.

In an embodiment, obtaining the existing UE address information and/or UE address change information related to the network based on the first subscribe request comprises sending a request for storing UE address monitoring data related to the first subscribe request to a data repository, and receiving an event exposure notify message comprising the existing UE address information and/or UE address change information related to the network from a policy control function.

In an embodiment, the exposure function comprises at least one of Service Capability Exposure Function (SCEF), Network Exposure Function (NEF), SCEF combined with NEF.

In a second aspect of the disclosure, there is provided a method performed by an application function. The method comprises sending a first subscribe request for subscribing existing user equipment (UE) address information and/or UE address change information related to a network to an exposure function. The method further comprises receiving the existing UE address information and/or UE address change information related to the network from the exposure function.

In an embodiment, the method further comprises sending a subscribe update request for updating a subscription created by the first subscribe request to the exposure function.

In an embodiment, the method further comprises receiving a subscribe update response from the exposure function.

In an embodiment, the method further comprises sending a unsubscribe request for deleting a subscription created by the first subscribe request to the exposure function.

In an embodiment, the method further comprises receiving a unsubscribe response from the exposure function.

In an embodiment, the existing UE address information is received in a first subscribe response or at least one UE address notification message.

In an embodiment, the UE address change information is received in at least one UE address notification message.

In a third aspect of the disclosure, there is provided a method performed by a first network function. The method comprise receiving a second subscribe request for subscribing the UE address information and/or UE address change information related to a network from a second network function. The method further comprises sending the UE address information and/or UE address change information related to the network to the second network function.

In an embodiment, the method further comprises receiving a subscribe update request for updating a subscription created by the second subscribe request from the second network function.

In an embodiment, the method further comprises sending a subscribe update response to the second network function.

In an embodiment, the method further comprises receiving an unsubscribe request for deleting a subscription created by the second subscribe request from the second network function.

In an embodiment, the method further comprises sending an unsubscribe response to the second network function.

In an embodiment, the first network function comprises at least one of a session management function, a binding support function, or a policy control function.

In an embodiment, the second network function is an exposure function or a network data analytics function (NWDAF).

In a fourth aspect of the disclosure, there is provided a method performed by a data repository. The method comprises receiving a request for storing user equipment (UE) address monitoring data for existing UE address information and/or UE address change information related to a network from an exposure function. The method further comprises storing the user equipment UE address monitoring data.

In an embodiment, the UE address monitoring data comprises an identifier of the network.

In an embodiment, the UE address monitoring data comprises an identifier of the network and a UE identifier.

In an embodiment, the UE address monitoring data comprises an identifier of the network and an address of a UE.

In an embodiment, the UE address monitoring data comprises an identifier of the network and a group identifier.

In an embodiment, the UE address monitoring data comprises at least one of single network slice selection assistance information (S-NSSAI), an indication of UE MAC address change event to be subscribed, an indication of UE IP address change event to be subscribed, an indication of whether existing UE address information shall be returned, a uniform resource identifier (URI) of a notification endpoint, reporting control information, a reporting filter.

In an embodiment, the method further comprises receiving an update request for updating the UE address monitoring data from the exposure function.

In an embodiment, the method further comprises sending an update response to the exposure function.

In an embodiment, the method further comprises receiving a deleting request for deleting a subscription created by the first subscribe request from the exposure function.

In an embodiment, the method further comprises sending a deleting response to the exposure function.

In an embodiment, the method further comprises receiving a subscribe request for the UE address monitoring data and/or UE address monitoring data change from a policy control function.

In an embodiment, the method further comprises sending the UE address monitoring data and/or UE address monitoring data change to the policy control function.

In an embodiment, the UE address monitoring data and/or UE address monitoring data change is sent in a subscribe response or a notify message.

In a fifth aspect of the disclosure, there is provided a method performed by a policy control function. The method comprises sending a subscribe request for user equipment (UE) address monitoring data and/or UE address monitoring data change for existing UE address information and/or UE address change information related to a network to a data repository. The method further comprises receiving the UE address monitoring data and/or UE address monitoring data change from the data repository. The method further comprises sending the existing UE address information and/or UE address change information related to the network to an exposure function based on the UE address monitoring data and/or UE address monitoring data change.

In an embodiment, the UE address monitoring data and/or UE address monitoring data change is received in a subscribe response or a notify message.

In a sixth aspect of the disclosure, there is provided an exposure function. The exposure function comprises a processor and a memory coupled to the processor. Said memory contains instructions executable by said processor. Said exposure function is operative to receive a first subscribe request for subscribing existing user equipment (UE) address information and/or UE address change information related to a network from an application function. Said exposure function is further operative to obtain the existing UE address information and/or UE address change information related to the network based on the first subscribe request. Said exposure function is further operative to send the existing UE address information and/or UE address change information related to the network to the application function.

In a seventh aspect of the disclosure, there is provided an application function. The application function comprises a processor and a memory coupled to the processor. Said memory contains instructions executable by said processor. Said application function is operative to send a first subscribe request for subscribing existing user equipment (UE) address information and/or UE address change information related to a network to an exposure function. Said application function is further operative to receive the existing UE address information and/or UE address change information related to the network from the exposure function.

In an eighth aspect of the disclosure, there is provided a first network function. The first network function comprises a processor and a memory coupled to the processor. Said memory contains instructions executable by said processor. Said first network function is operative to receive a second subscribe request for subscribing the UE address information and/or UE address change information related to a network from a second network function. Said first network function is operative to send the UE address information and/or UE address change information related to the network to the second network function.

In a ninth aspect of the disclosure, there is provided a data repository. The data repository comprises a processor and a memory coupled to the processor. Said memory contains instructions executable by said processor. Said data repository is operative to receive a request for storing user equipment (UE) address monitoring data for existing UE address information and/or UE address change information related to a network from an exposure function. Said data repository is further operative to store the user equipment UE address monitoring data.

In a tenth aspect of the disclosure, there is provided a policy control function. The policy control function comprises a processor and a memory coupled to the processor. Said memory containing instructions executable by said processor. Said policy control function is operative to send a subscribe request for user equipment (UE) address monitoring data and/or UE address monitoring data change for existing UE address information and/or UE address change information related to a network to a data repository. Said policy control function is further operative to receive the UE address monitoring data and/or UE address monitoring data change from the data repository. Said policy control function is further operative to send the existing UE address information and/or UE address change information related to the network to an exposure function based on the UE address monitoring data and/or UE address monitoring data change.

In another aspect of the disclosure, there is provided an exposure function. The exposure function comprises a first receiving module, an obtaining module and a first sending module. The first receiving module may be configured to receive a first subscribe request for subscribing existing user equipment (UE) address information and/or UE address change information related to a network from an application function. The obtaining module may be configured to obtain the existing UE address information and/or UE address change information related to the network based on the first subscribe request. The sending module may be configured to send the existing UE address information and/or UE address change information related to the network to the application function.

In an embodiment, the exposure function may further comprise a second receiving module configured to receive a subscribe update request for updating a subscription created by the first subscribe request from the application function.

In an embodiment, the exposure function may further comprise a second sending module configured to send a subscribe update response to the application function.

In an embodiment, the exposure function may further comprise a third receiving module configured to receive an unsubscribe request for deleting a subscription created by the first subscribe request from the application function.

In an embodiment, the exposure function may further comprise a third sending module configured to send an unsubscribe response to the application function.

In an embodiment, the exposure function may further comprise a fourth sending module configured to send a subscribe update request for updating a subscription created by the second subscribe request to the first network function.

In an embodiment, the exposure function may further comprise a fourth receiving module configured to receive a subscribe update response from the first network function.

In an embodiment, the exposure function may further comprise a fifth sending module configured to send an unsubscribe request for deleting a subscription created by the second subscribe request to the first network function.

In an embodiment, the exposure function may further comprise a fifth receiving module configured to receive an unsubscribe response from the first network function.

In another aspect of the disclosure, there is provided an application function. The application function comprises a first sending module and a first receiving module. The first sending module may be configured to send a first subscribe request for subscribing existing user equipment (UE) address information and/or UE address change information related to a network to an exposure function. The first receiving module may be configured to receive the existing UE address information and/or UE address change information related to the network from the exposure function.

In an embodiment, the application function may further comprise a second sending module configured to send a subscribe update request for updating a subscription created by the first subscribe request to the exposure function.

In an embodiment, the application function may further comprise a second receiving module configured to receive a subscribe update response from the exposure function.

In an embodiment, the application function may further comprise a third sending module configured to send a unsubscribe request for deleting a subscription created by the first subscribe request to the exposure function.

In an embodiment, the application function may further comprise a third receiving module configured to receive a unsubscribe response from the exposure function.

In another aspect of the disclosure, there is provided a first network function. The first network function comprises a first receiving module and a first sending module. The first receiving module may be configured to receive a second subscribe request for subscribing the UE address information and/or UE address change information related to a network from a second network function. The first sending module may be configured to send the UE address information and/or UE address change information related to the network to the second network function.

In an embodiment, the first network function may further comprise a second receiving module and a second sending module. The second receiving module may be configured to receive a subscribe update request for updating a subscription created by the second subscribe request from the second network function. The second sending module may be configured to send a subscribe update response to the second network function.

In an embodiment, the first network function may further comprise a third receiving module and a third sending module. The first receiving module may be configured to receive an unsubscribe request for deleting a subscription created by the second subscribe request from the second network function. The first sending module may be configured to send an unsubscribe response to the second network function.

In another aspect of the disclosure, there is provided a data repository. The data repository comprises a first receiving module and a storing module. The first receiving module may be configured to receive a request for storing user equipment (UE) address monitoring data for existing UE address information and/or UE address change information related to a network from an exposure function. The storing module may be configured to store the user equipment UE address monitoring data.

In an embodiment, the data repository may further comprise a second receiving module and a first sending module. The second receiving module may be configured to receive an update request for updating the UE address monitoring data from the exposure function. The first sending module may be configured to send an update response to the exposure function.

In an embodiment, the data repository may further comprise a third receiving module and a second sending module. The third receiving module may be configured to receive a deleting request for deleting a subscription created by the first subscribe request from the exposure function. The second sending module may be configured to send a deleting response to the exposure function.

In an embodiment, the data repository may further comprise a fourth receiving module and a third sending module. The fourth receiving module may be configured to receive a subscribe request for the UE address monitoring data and/or UE address monitoring data change from a policy control function. The third sending module may be configured to send the UE address monitoring data and/or UE address monitoring data change to the policy control function.

In another aspect of the disclosure, there is provided a policy control function. The policy control function comprises a first sending module, a first receiving module and a second sending module. The first sending module may be configured to send a subscribe request for user equipment (UE) address monitoring data and/or UE address monitoring data change for existing UE address information and/or UE address change information related to a network to a data repository. The first receiving module may be configured to receive the UE address monitoring data and/or UE address monitoring data change from the data repository. The second sending module may be configured to send the existing UE address information and/or UE address change information related to the network to an exposure function based on the UE address monitoring data and/or UE address monitoring data change.

In another aspect of the disclosure, there is provided a computer program product comprising instructions which when executed by at least one processor, cause the at least one processor to perform the method according to any one of the first, second, third, fourth and fifth aspects.

In another aspect of the disclosure, there is provided a computer-readable storage medium storing instructions which when executed by at least one processor, cause the at least one processor to perform the method according to any one of the first, second, third, fourth and fifth aspects.

Embodiments herein may provide many advantages, of which a non-exhaustive list of examples follows. In some embodiments herein, the proposed solution can enable a device such as application function to get the UE address (change) information of a network such as 5G LAN VN or a DN via an exposure function (e.g., NEF). In some embodiments herein, the proposed solution can enable an exposure function (e.g., NEF) to get the UE address (change) information of a network such as a 5G LAN VN or a DN from other network function(s) such as 5GC NFs. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a local-switch based user plane architecture in non-roaming scenario;

FIG. 2 shows a N19-based user plane architecture in non-roaming scenario;

FIG. 3 shows a scenario of Multi-homed PDU session of local access to same DN;

FIG. 4 shows a scenario of multiple Ethernet devices behind UE in 5G LAN type service;

FIG. 5 schematically shows a high level architecture in the fifth generation network according to an embodiment of the present disclosure;

FIG. 6 schematically shows system architecture in a 4G network according to an embodiment of the present disclosure;

FIG. 7 shows non-roaming architecture for Network Exposure Function in reference point representation;

FIG. 8 shows non-roaming Service Exposure Architecture for EPC (Evolved Packet Core)-5GC Interworking;

FIG. 9 shows a flowchart of a method according to an embodiment of the present disclosure;

FIG. 10 shows a flowchart of a method according to another embodiment of the present disclosure;

FIG. 11 shows a flowchart of a method according to another embodiment of the present disclosure;

FIG. 12 shows a flowchart of AF subscribes the UE address change of a 5G LAN VN or a DN via a new API according to an embodiment of the present disclosure;

FIG. 13 shows a flowchart of AF subscribes the UE address change of a specific UE of a 5G LAN VN or DN via a new API according to an embodiment of the present disclosure;

FIG. 14 shows a flowchart of AF subscribes the UE address change of a specific UE PDU session of a 5G LAN VN or DN via a new API according to an embodiment of the present disclosure;

FIG. 15 shows a flowchart of AF subscribes the UE address change of a group of UEs for a DN via a new API according to an embodiment of the present disclosure;

FIG. 16 shows a flowchart of AF subscribes the UE address change of a 5G LAN VN or DN via enhanced Nnef_EventExposure API according to an embodiment of the present disclosure;

FIG. 17 shows a flowchart of AF subscribes the UE address change of a specific UE of a 5G LAN VN or a DN via enhanced Nnef_EventExposure API according to an embodiment of the present disclosure;

FIG. 18 shows a flowchart of AF subscribe the UE address change of a specific UE PDU session of a 5G LAN VN or a DN via enhanced Nnef_EventExposure API according to an embodiment of the present disclosure;

FIG. 19 shows a flowchart of AF subscribe the UE address change of a group of UEs for a DN via enhanced Nnef_EventExposure API according to an embodiment of the present disclosure;

FIG. 20 shows a flowchart of obtaining the existing UE address information and/or UE address change information related to the network according to an embodiment of the present disclosure;

FIG. 21 shows a flowchart of a method according to another embodiment of the present disclosure;

FIG. 22 shows a flowchart of a method according to another embodiment of the present disclosure;

FIG. 23 shows a flowchart of AF subscribes the UE address change of a 5G LAN VN or DN via a new API and NEF collects UE address change information from SMF(s) according to an embodiment of the present disclosure;

FIG. 24 shows a flowchart of AF subscribes the UE address change of a specific UE of the 5G LAN VN or DN via a new API and NEF collects UE address change information from SMF according to an embodiment of the present disclosure;

FIG. 25 shows a flowchart of AF subscribes the UE address change of a specific PDU session of the 5G LAN VN or DN via a new API and NEF collects UE address change information from SMF according to an embodiment of the present disclosure;

FIG. 26 shows a flowchart of AF subscribes the UE address change of a group of UEs for a DN via a new API and NEF collects UE address change information from SMF according to an embodiment of the present disclosure;

FIG. 27 shows a flowchart of AF subscribes the UE address change of a 5G LAN VN or DN via an existing API and NEF collects UE address change information from SMF(s) according to an embodiment of the present disclosure;

FIG. 28 shows a flowchart of AF subscribes the UE address change of a specific UE of the 5G LAN VN or DN via an existing API and NEF collects UE address change information from SMF according to an embodiment of the present disclosure;

FIG. 29 shows a flowchart of AF subscribes the UE address change of a specific PDU session of the 5G LAN VN or DN via an existing API and NEF collects UE address change information from SMF according to an embodiment of the present disclosure;

FIG. 30 shows a flowchart of AF subscribes the UE address change of a group of UEs for a DN via an existing API and NEF collects UE address change information from SMF according to an embodiment of the present disclosure;

FIG. 31 shows a flowchart of AF subscribes the UE address change of a 5G LAN VN or DN via an existing API and NEF collects UE address change information directly from PCF(s) according to an embodiment of the present disclosure;

FIG. 32 shows a flowchart of AF subscribes the UE address change of a specific PDU session via an existing API and NEF collects UE address change information directly from serving PCF according to an embodiment of the present disclosure;

FIG. 33 shows a flowchart of AF subscribes the UE address change of a 5G LAN VN or DN via an existing API and NEF collects UE address change information from BSF(s) according to an embodiment of the present disclosure;

FIG. 34 shows a flowchart of obtaining the existing UE address information and/or UE address change information related to the network according to another embodiment of the present disclosure;

FIG. 35 shows a new resource for new 5G UE address monitoring data as one of Application Data according to an embodiment of the present disclosure;

FIG. 36 shows a flowchart of AF subscribes the UE address change of a 5G LAN VN or DN via an existing API and NEF collects UE address change info indirectly from PCF(s) according to an embodiment of the present disclosure;

FIG. 37 shows a flowchart of a method according to another embodiment of the present disclosure;

FIG. 38 shows a flowchart of a method according to another embodiment of the present disclosure;

FIG. 39 shows a flowchart of a method according to another embodiment of the present disclosure;

FIG. 40 shows a flowchart of a method according to another embodiment of the present disclosure;

FIG. 41 shows a flowchart of a method according to another embodiment of the present disclosure;

FIG. 42 shows a flowchart of a method according to another embodiment of the present disclosure;

FIG. 43 shows a flowchart of a method according to another embodiment of the present disclosure;

FIG. 44 shows a flowchart of a method according to another embodiment of the present disclosure;

FIG. 45 shows a flowchart of a method according to another embodiment of the present disclosure;

FIG. 46 shows a flowchart of a method according to another embodiment of the present disclosure;

FIG. 47 shows a flowchart of a method according to another embodiment of the present disclosure;

FIG. 48 is a block diagram showing an apparatus suitable for practicing some embodiments of the disclosure;

FIG. 49 is a block diagram showing an exposure function according to an embodiment of the disclosure;

FIG. 50 is a block diagram showing an application function according to an embodiment of the disclosure;

FIG. 51 is a block diagram showing a first network function according to an embodiment of the disclosure;

FIG. 52 is a block diagram showing a data repository according to an embodiment of the disclosure; and

FIG. 53 is a block diagram showing a policy control function according to an embodiment of the disclosure.

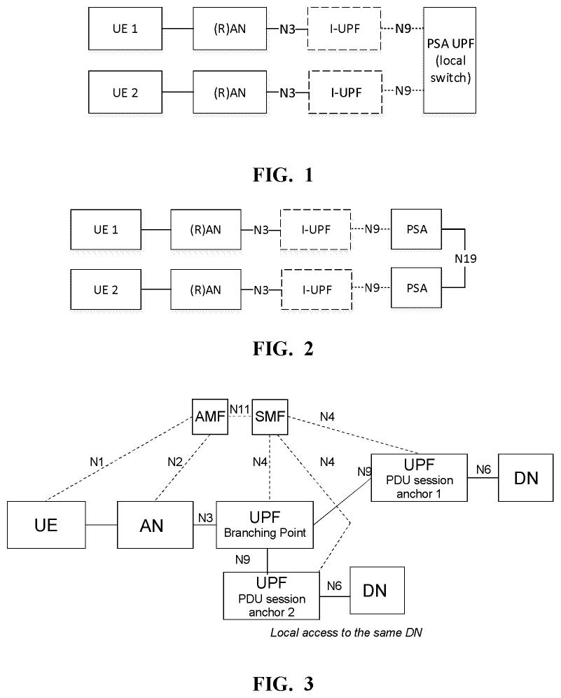

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP' LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

Although the subject matter described herein may be implemented in any appropriate type of system using any suitable components, the embodiments disclosed herein are described in relation to a communication system complied with the exemplary system architectures illustrated in FIGS. 5-8. For simplicity, the system architectures of FIGS. 5-8 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

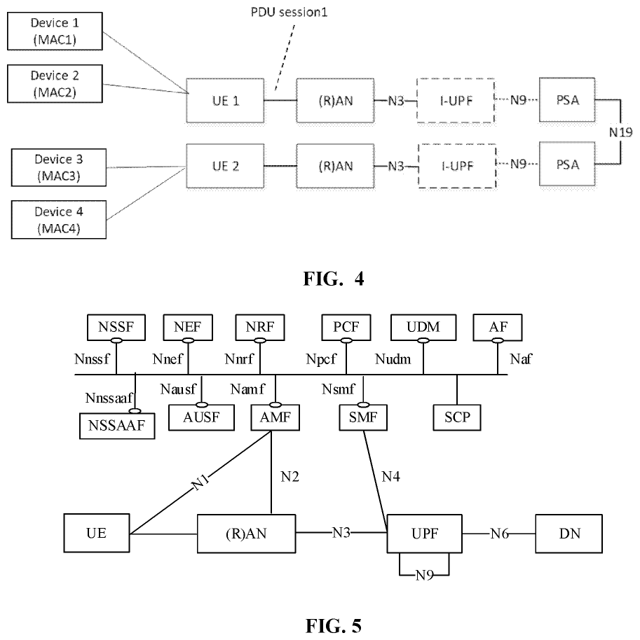

FIG. 5 schematically shows a high level architecture in the fifth generation network according to an embodiment of the present disclosure. For example, the fifth generation network may be 5GS. The architecture of FIG. 5 is same as FIG. 4.2.3-1 as described in 3GPP TS 23.501 V16.7.0, the disclosure of which is incorporated by reference herein in its entirety. The system architecture of FIG. 5 may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), etc.

In accordance with an exemplary embodiment, the UE can establish a signaling connection with the AMF over the reference point N1, as illustrated in FIG. 5. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 5, the exemplary system architecture also contains the service-based interfaces such as Nnrf, Nnef, Nausf, Nudm, Npcf, Namf and Nsmf exhibited by NFs such as the NRF, the NEF, the AUSF, the UDM, the PCF, the AMF and the SMF. In addition, FIG. 5 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 5 may be responsible for functions such as session management, mobility management, authentication, security, etc. The AUSF, AMF, DN, NEF, NRF, NSSF, PCF, SMF, UDM, UPF, AF, UE, (R)AN, SCP may include the functionality for example as defined in clause 6.2 of 3GPP TS23.501 V16.7.0.

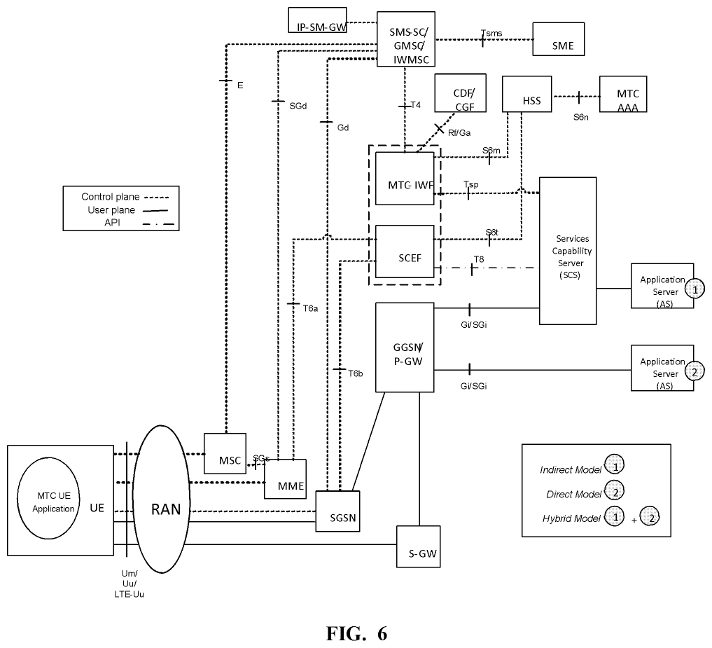

FIG. 6 schematically shows system architecture in a 4G network according to an embodiment of the present disclosure, which is the same as FIG. 4.2-1a of 3GPP TS 23.682 V16.8.0, the disclosure of which is incorporated by reference herein in its entirety. The system architecture of FIG. 6 may comprise some exemplary elements such as Services Capability Server (SCS), Application Server (AS), SCEF (Service Capability Exposure Function), HSS, UE, RAN(Radio Access Network), SGSN (Serving GPRS (General Packet Radio Service) Support Node), MME, MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC(Short Message Service-Service Centre/Gateway MSC/InterWorking MSC) IP-SM-GW (Internet protocol Short Message Gateway). The network elements and interfaces as shown in FIG. 6 may be same as the corresponding network elements and interfaces as described in 3GPP TS 23.682 V16.8.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 6, the exemplary system architecture also contains various reference points.

Tsms: Reference point used by an entity outside the 3GPP network to communicate with UEs used for MTC via SMS (Short Message Service).

Tsp: Reference point used by a SCS to communicate with the MTC-IWF related control plane signalling.

T4: Reference point used between MTC-IWF and the SMS-SC in the HPLMN.

T6a: Reference point used between SCEF and serving MME.

T6b: Reference point used between SCEF and serving SGSN.

T8: Reference point used between the SCEF and the SCS/AS.

S6m: Reference point used by MTC-IWF to interrogate HSS/HLR.

S6n: Reference point used by MTC-AAA to interrogate HSS/HLR.

S6t: Reference point used between SCEF and HSS.

SGs: Reference point used between MSC and MME.

Gi/SGi: Reference point used between GGSN/P-GW and application server and between GGSN/P-GW and SCS.

Rf/Ga: Reference point used between MTC-IWF and CDF/CGF.

Gd: Reference point used between SMS-SC/GMSC/IWMSC and SGSN.

SGd: Reference point used between SMS-SC/GMSC/IWMSC and MME.

E: Reference point used between SMS-SC/GMSC/IWMSC and MSC.

The end-to-end communications, between the MTC Application in the UE and the MTC Application in the external network, uses services provided by the 3GPP system, and optionally services provided by a Services Capability Server (SCS).

The MTC Application in the external network is typically hosted by an Application Server (AS) and may make use of an SCS for additional value added services. The 3GPP system provides transport, subscriber management and other communication services including various architectural enhancements motivated by, but not restricted to, MTC (e.g. control plane device triggering).

Different models are foreseen for machine type of traffic in what relates to the communication between the AS and the 3GPP system and based on the provider of the SCS. The different architectural models that are supported by the Architectural Reference Model include the Direct Model, Indirect Model and Hybrid Model as described in 3GPP TS 23.682 V16.8.0.

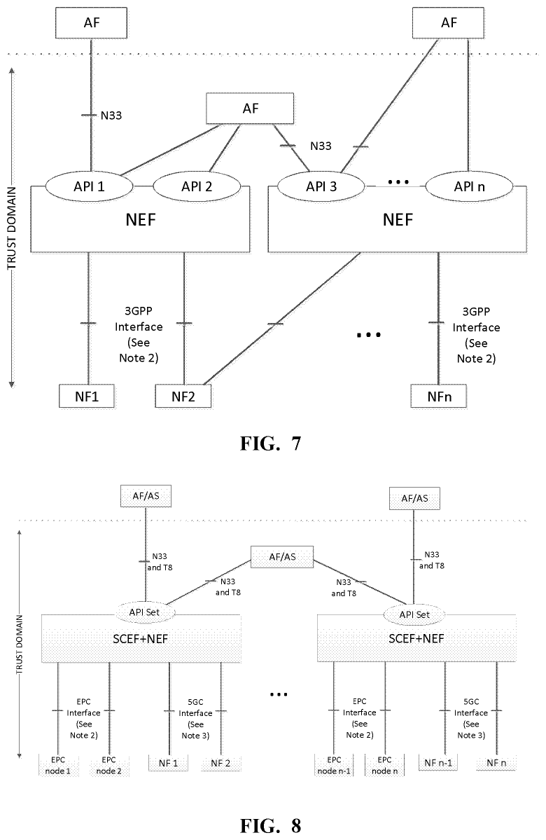

FIG. 7 shows non-roaming architecture for Network Exposure Function in reference point representation, which is same as FIG. 4.2.3-5 of 3GPP TS23.501 V16.7.0. 3GPP Interface represents southbound interfaces between NEF and 5GC Network Functions e.g. N29 interface between NEF and SMF, N30 interface between NEF and PCF, etc. All southbound interfaces from NEF are not shown for the sake of simplicity. N33 is a reference point between NEF and AF.

FIG. 8 shows non-roaming Service Exposure Architecture for EPC (Evolved Packet Core)-5GC Interworking, which is same as FIG. 4.3.5.1 1 of 3GPP TS23.501 V16.7.0. If the UE is capable of mobility between EPS and 5GS, the network is expected to associate the UE with an SCEF+NEF (SCEF combined with NEF) node for Service Capability Exposure. Trust domain for SCEF+NEF is same as Trust domain for SCEF as defined in 3GPP TS 23.682 V16.8.0. EPC Interface represents southbound interfaces between SCEF and EPC nodes e.g. the S6t interface between SCEF and HSS, the T6a interface between SCEF and MME, etc. All southbound interfaces from SCEF are defined in 3GPP TS 23.682 V16.8.0 and are not shown for the sake of simplicity. 5GC Interface represents southbound interfaces between NEF and 5GC Network Functions e.g. N29 interface between NEF and SMF, N30 interface between NEF and PCF, etc. All southbound interfaces from NEF are not shown for the sake of simplicity. Interaction between the SCEF and NEF within the combined SCEF+NEF is required. For example, when the SCEF+NEF supports monitoring APIs, the SCEF and NEF need to share context and state information on a UE's configured monitoring events if the UE moves between from EPC and 5GC. The north-bound APIs which can be supported by an EPC or 5GC network are discovered by the SCEF+NEF node via the CAPIF (Common API Framework for 3GPP northbound APIs) function and/or via local configuration of the SCEF+NEF node. Different sets of APIs can be supported by the two network types.

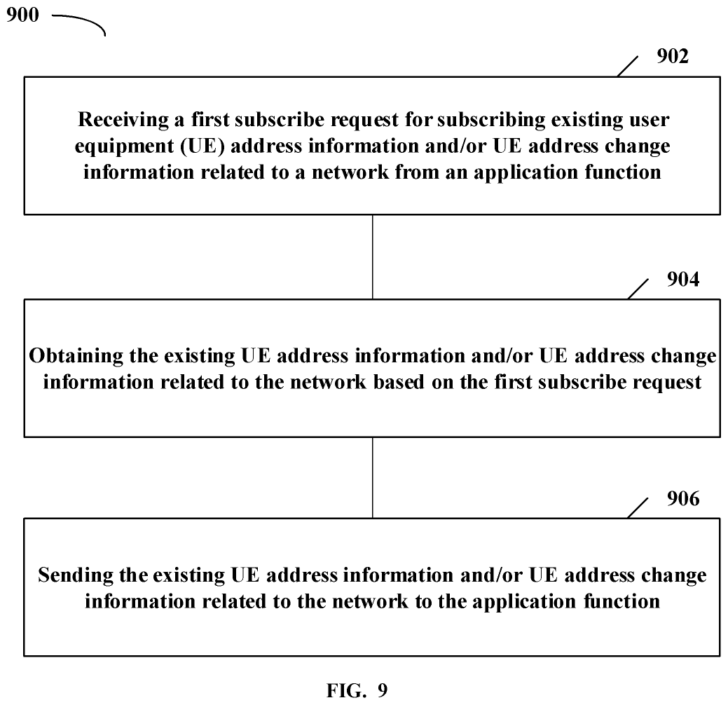

FIG. 9 shows a flowchart of a method according to an embodiment of the present disclosure, which may be performed by an apparatus implemented in or at or as an exposure function or communicatively coupled to the exposure function. As such, the apparatus may provide means or modules for accomplishing various parts of the method 900 as well as means or modules for accomplishing other processes in conjunction with other components.

The exposure function may provide a means to securely expose the services, events and capabilities provided by network interfaces. The exposure function may provide a means for the discovery of the exposed services and capabilities. The exposure function may provide access to network capabilities through homogenous network application programming interfaces (e.g. Network APIs). The exposure function may abstract the services from the underlying network interfaces and protocols. In an embodiment, the exposure function may comprise at least one of SCEF, NEF, SCEF+NEF.

At block 902, the exposure function may receive a first subscribe request for subscribing existing UE address information and/or UE address change information related to a network from an application function.

The application function may interact with the network (such as 3GPP Core Network) in order to provide services. In an embodiment, the application function may be AF or AS.

The network may be any suitable network such as public network or private network. In an embodiment, the network comprises at least one of a local area network (LAN) virtual network (such as 5G LAN VN); or a data network (such as DN).

An address of a UE may be any suitable address related to the UE, such as address used by the UE or address used by a device connected to the UE. In an embodiment, an address of a UE may comprise at least one of an Internet Protocol (IP) address used by the UE; a Medium Access Control (MAC) address used by the UE; an IP address used by at least one device connected to the UE; or a MAC address used by at least one device connected to the UE. The device connected to the UE may comprise any device locally connected to the UE. For example, in a home or office, there may be various devices locally connected to the UE and use the PDU session or PDN connection of the UE to communicate with the DN.

In an embodiment, the existing UE address information and/or UE address change information related to the network may comprise at least one of the existing UE address information and/or UE address change information of the network; the existing UE address information and/or UE address change information of a UE of the network; the existing UE address information and/or UE address change information of a session (such as PDU session or PDN connection) of the network; or the existing UE address information and/or UE address change information of a group of UEs of the network.

The first subscribe request may be a new subscribe request or an modified existing subscribe request. The first subscribe request may comprise any suitable parameters for subscribing existing UE address information and/or UE address change information related to the network.

In an embodiment, the first subscribe request may comprise an identifier of the network. This first subscribe request may be used to subscribe existing UE address information and/or UE address change information of the network. For example, the identifier of the network may be DNN or External Group ID. As described in 3GPP TS 23.502 V16.7.1, the External Group ID may identify the 5G VN Group.

In an embodiment, the first subscribe request may comprise an identifier of the network and a UE identifier. For example, the UE identifier may be GPSI (Generic Public Subscription Identifier) or SUPI (Subscription Permanent Identifier). This first subscribe request may be used to subscribe existing UE address information and/or UE address change information of a UE of the network.

In an embodiment, the first subscribe request may comprise an identifier of the network and an address of a UE. The address of the UE may comprise IP address or MAC address. This first subscribe request may be used to subscribe existing UE address information and/or UE address change information of a session (such as PDU session or PDN connection, etc.) of the network.

In an embodiment, the first subscribe request may comprise an identifier of the network and a group identifier (such as external group identifier or internal group identifier). The group identifier may identify a group of UEs. The external group identifier may be an group identifier used by any device outside the network. The internal group identifier may be an group identifier used by any device inside the network. This first subscribe request may be used to subscribe existing UE address information and/or UE address change information of a group of UEs of the network. In this embodiment, the group identifier may be used to identify a group of UEs of the network.

In an embodiment, the first subscribe request may comprise at least one of single network slice selection assistance information (S-NSSAI), an indication of UE MAC address change event to be subscribed, an indication of UE IP address change event to be subscribed, an indication of whether existing UE address information shall be returned, a uniform resource identifier (URI) of a notification endpoint, reporting control information, a reporting filter. These subscribe parameters in the first subscribe request may be used by exposure function to obtain the existing UE address information and/or UE address change information related to the network satisfying the subscribe parameters in the first subscribe request.

In an embodiment, the reporting control information comprises periodic reporting interval or report frequency.

In an embodiment, the reporting filter comprises at least one of a UE address change type, an IP range, an MAC range, or a UE identifier range.

In an embodiment, the UE address change type comprises at least one of a type of new UE address, a type of obsoleted (or deprecated or removed) UE address, or a type of existing UE address.

At block 904, the exposure function may obtain the existing UE address information and/or UE address change information related to the network based on the first subscribe request. The exposure function may obtain the existing UE address information and/or UE address change information related to the network in various ways, for example, from another network function which stores or can obtain the existing UE address information and/or UE address change information related to the network. The existing UE address information and/or UE address change information related to the network may be obtained in same or different messages. For example, the exposure function may first obtain the existing UE address information related to the network and then obtain the UE address change information related to the network.

At block 906, the exposure function may send the existing UE address information and/or UE address change information related to the network to the application function. The existing UE address information and/or UE address change information related to the network may be sent in same or different messages. For example, the exposure function may first send the existing UE address information related to the network to the application function and then send the UE address change information related to the network to the application function. In an embodiment, the existing UE address information is sent in a first subscribe response or at least one UE address notification message. In an embodiment, the UE address change information is sent in at least one UE address notification message.

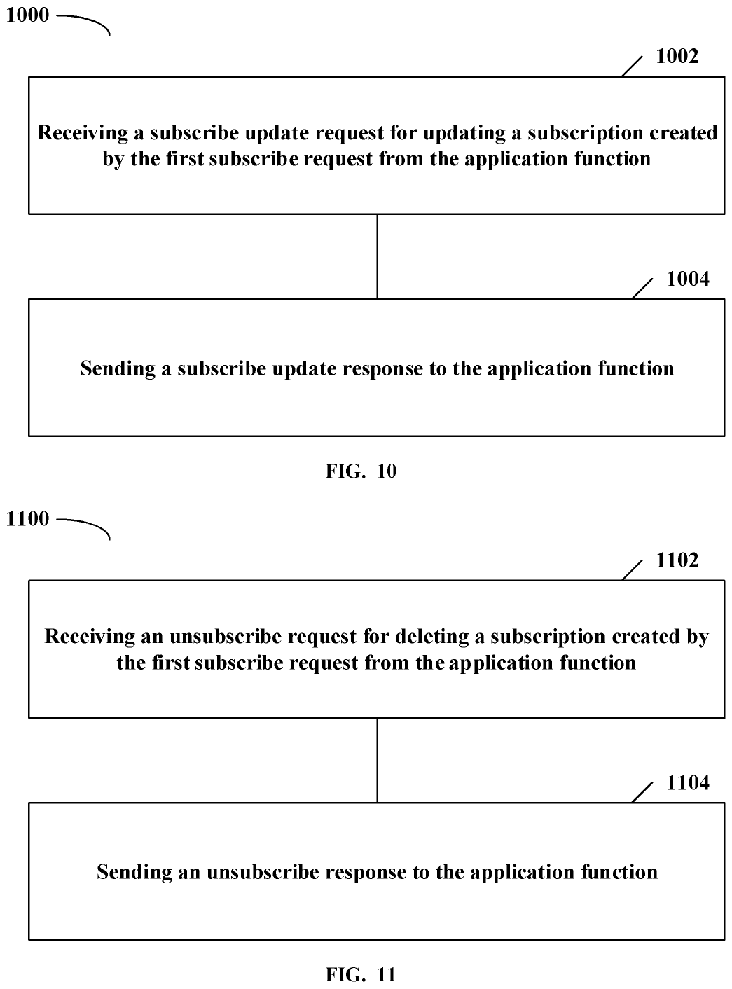

FIG. 10 shows a flowchart of a method according to another embodiment of the present disclosure, which may be performed by an apparatus implemented in or at or as an exposure function or communicatively coupled to the exposure function. As such, the apparatus may provide means or modules for accomplishing various parts of the method 1000 as well as means or modules for accomplishing other processes in conjunction with other components. For some parts which have been described in the above embodiments, the description thereof is omitted here for brevity.

At block 1002, the exposure function may receive a subscribe update request for updating a subscription created by the first subscribe request from the application function. For example, the subscribe update request may comprise a subscription correlation ID and attribute(s) to be updated (e.g., modified or added or deleted), e.g. parameters (such as reporting control information, reporting filter information, etc.) comprised in the first subscribe request. The exposure function may perform a subscribe update operation and generate a subscribe update operation execution result indication.

At block 1004, the exposure function may send a subscribe update response to the application function. The subscribe update response may comprise a subscribe update operation execution result indication.

For example, the exposure function may obtain the existing UE address information and/or UE address change information related to the network based on the updated first subscribe request and send the obtained existing UE address information and/or UE address change information related to the network to the application function.

FIG. 11 shows a flowchart of a method according to another embodiment of the present disclosure, which may be performed by an apparatus implemented in or at or as an exposure function or communicatively coupled to the exposure function. As such, the apparatus may provide means or modules for accomplishing various parts of the method 1100 as well as means or modules for accomplishing other processes in conjunction with other components. For some parts which have been described in the above embodiments, the description thereof is omitted here for brevity.

At block 1102, the exposure function may receive an unsubscribe request for deleting a subscription created by the first subscribe request from the application function. For example, the unsubscribe request may comprise a subscription correlation ID. The exposure function may perform an unsubscribe operation and generate an unsubscribe operation execution result indication.

At block 1104, the exposure function may send an unsubscribe response to the application function. The unsubscribe response may comprise an unsubscribe operation execution result indication.

For example, after deleting a subscription created by the first subscribe request, the exposure function may not obtain the existing UE address information and/or UE address change information related to the network and may not send the existing UE address information and/or UE address change information related to the network to the application function.

In an embodiment, a new 5G UE address monitoring API is exposed to AF via NEF. The new 5G UE address monitoring API (e.g., 5G_UE_AddrMonte_API) as following is to expose following operations to AF.

5G_UE_AddrMonte_Subscribe: Subscription on UE address change of a 5G LAN VN or a DN
Input/request
   External group ID
   DNN
   S-NSSAI
   UE ID (e.g. GPSI or SUPI)
   UE address (IP, or MAC)
      If only external group ID or DNN exists, it indicates the subscription on UE address change of a 5G LAN VN (identified by the external group ID) or a DN (identified by DNN)
      If external group ID or DNN, and UE ID exist, it indicates the subscription on UE address change of a specific UE of a 5G LAN VN or a DN.
      If external group ID or DNN, and UE address exist, it indicates the subscription on UE address change of a specific UE PDU session of a 5G LAN VN or a DN
      If both external group ID and DNN exist, it indicates the subscription on UE address change of a group of UEs (identified by the external group ID) for a DN (identified by DNN)
   Events (ID) to be subscribed, e.g., UE MAC address change, UE IP address change
   An existing-address indication: an indicator to indicate if the existing UE address information shall be returned or not.
   Notification endpoint URI
   Reporting control information (e.g. report frequency, etc.)
   Reporting filter (e.g., filtered by UE address change type (new, removed, existing), IP ranges, MAC ranges, UE ID ranges)
Output/response
   Operation execution result indication
   When the subscription is accepted: Subscription Correlation ID, list of UE address change information (see definition in 5G_UE_AddrMonte_Notify) for existing UE address information, if existing-address indication is set in the request to return existing UE address information. (Note)

5G_UE_AddrMonte_Notify: Notification on the UE address change of a 5G LAN VN or a DN
Input/notification
   Event ID (e.g., UE MAC address change, UE IP address change)
   List of UE address change information (Note)
      UE ID (e.g. SUPI or GPSI)
      UE address information list of this UE ID
         UE address (IPv4 address, or IPv6 address and prefix, or MAC)
         UE address change type
         new address,
         removed/obsoleted address, or
         existing address.
Output/response
   Result Indication
      Note: if AF indicates to return existing UE address information via the existing-address indication, an approach is to return existing UE address information in the response of 5G_UE_AddrMonte_Subscribe. Another approach is to return existing UE address information via one or multiple 5G_UE_AddrMonte_Notify.

5G_UE_AddrMonte_Update: Update an existing subscription created by 5G_UE_AddrMonte_Subscribe
Input:
   Subscription Correlation ID
   Attributes to be updated (e.g., modified or added or deleted), e.g. Reporting control information, Reporting filter information.
Output:
   Operation execution result indication

5G_UE_AddrMonte_Unsubscribe: Delete an existing subscription created by 5G_UE_AddrMonte_Subscribe
Input:
   Subscription Correlation ID
Output:
   Operation execution result indication

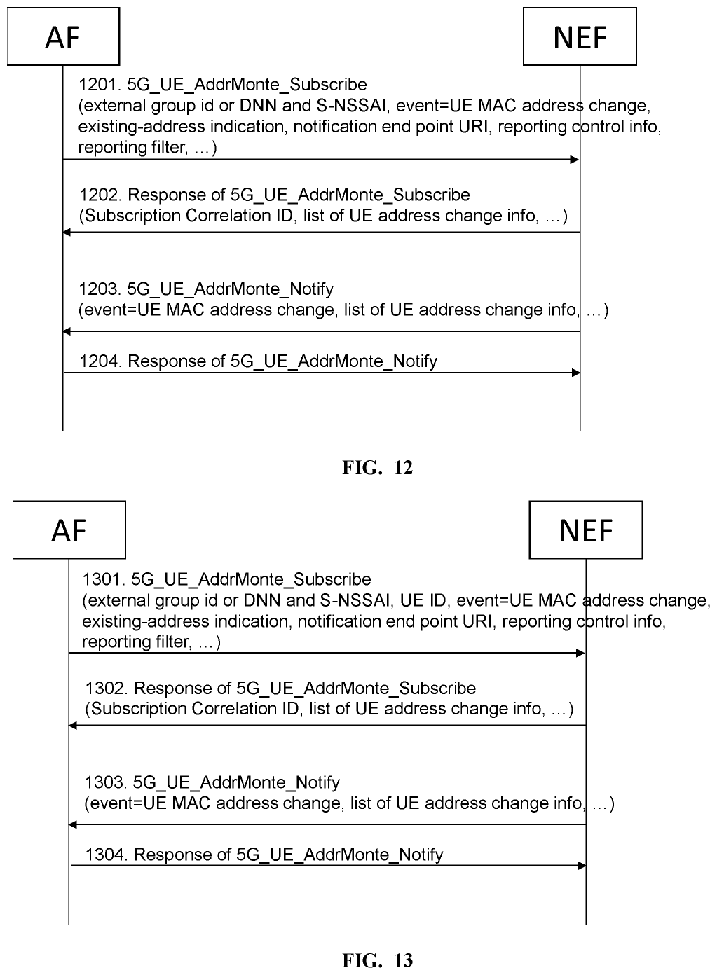

FIG. 12 shows a flowchart of AF subscribes the UE address change of a 5G LAN VN or a DN via a new API according to an embodiment of the present disclosure.

Step 1201: AF invokes 5G_UE_AddrMonte_Subscribe service operation via NEF to subscribe the UE address change information of a 5G LAN VN or a DN. The attributes of this service operation include the external group ID of the concerned 5G LAN VN or a DNN and a S-NSSAI, the event to be subscribed (e.g., UE MAC address change), an existing-address indication to indicate if existing UE address information shall be returned so AF can build a full view of the UE address information of the 5G LAN VN or DN together with later UE address change information notify, the notification endpoint URI, and other attributes.

Step 1202: NEF receives the 5G_UE_AddrMonte_Subscribe service operation, and may interact with 5GC NFs. NEF sends a response back to AF. The response contains the subscription correlation ID to identify this subscription, and a list of UE address change information for existing UE address information of the 5G LAN VN or DN if existing-address indication is received in the subscription service operation. Alternatively, instead of returning existing UE address information in the response, NEF may send the existing UE address information via one or multiple 5G_UE_AddrMonte_Notify.

Step 1203: NEF may get the UE address change information of any UE connected to this 5G LAN VN or DN, and NEF sends the 5G_UE_AddrMonte_Notify service operation to the notification endpoint URI in the subscription service operation with the event ID (e.g., UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address, or existing address) are indicated.

Step 1204: AF sends a response of 5G_UE_AddrMonte_Notify to NEF.

FIG. 13 shows a flowchart of AF subscribes the UE address change of a specific UE of a 5G LAN VN or DN via a new API according to an embodiment of the present disclosure.

Step 1301: AF invokes 5G_UE_AddrMonte_Subscribe service operation via NEF to subscribe the UE address change information of a specific UE of a 5G LAN VN or DN. The attributes of this service operation include the external group ID of the concerned 5G LAN VN or a DNN and a S-NSSAI, the UE ID (e.g., GPSI or SUPI), the event to be subscribed (e.g., UE MAC address change), an existing-address indication to indicate if existing UE address information shall be returned so AF can build a full view of the UE address information of the 5G LAN VN or DN together with later UE address change information notify, the notification endpoint URI, and other attributes.

Step 1302: NEF receives the 5G_UE_AddrMonte_Subscribe service operation, and may interact with 5GC NFs. NEF sends a response back to AF. The response contains the subscription correlation ID to identify this subscription, and a list of UE address change information for existing UE address information of the specific UE of the 5G LAN VN or DN if existing-address indication is received in the subscription service operation. Alternatively, instead of returning existing UE address information in the response, NEF may send the existing UE address information via one or multiple 5G_UE_AddrMonte_Notify.

Step 1303: NEF may get the UE address change information of this specific UE connected to this 5G LAN VN or DN, and NEF sends the 5G_UE_AddrMonte_Notify service operation to the notification endpoint URI in the subscription service operation with the event ID (e.g., UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address or existing address) are indicated.

Step 1304: AF sends a response of 5G_UE_AddrMonte_Notify to NEF.

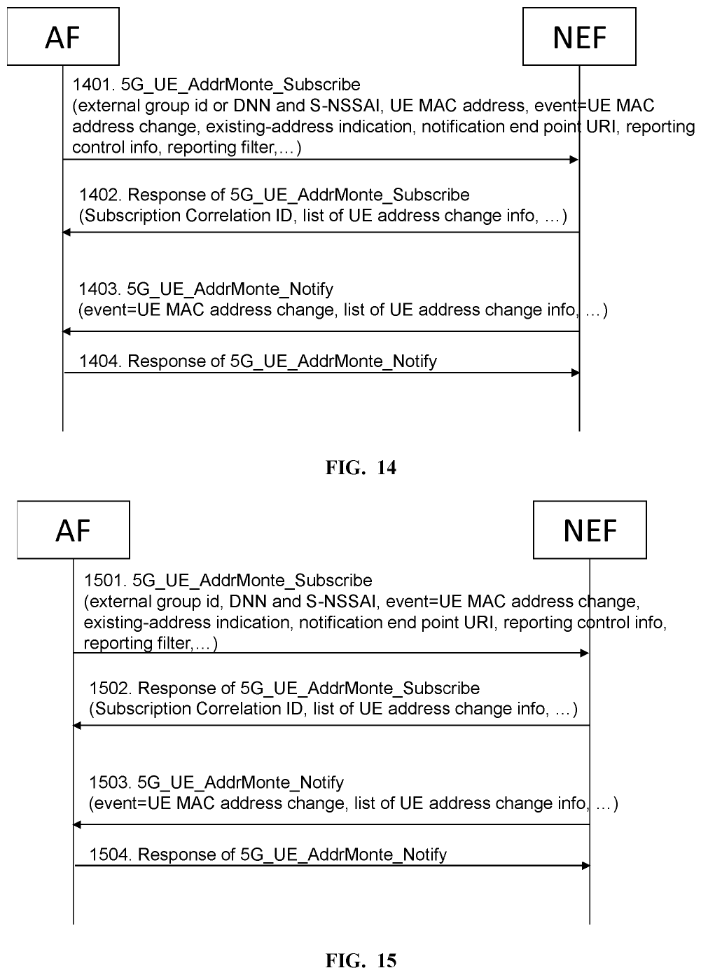

FIG. 14 shows a flowchart of AF subscribes the UE address change of a specific UE PDU session of a 5G LAN VN or DN via a new API according to an embodiment of the present disclosure.

Step 1401: AF invokes 5G_UE_AddrMonte_Subscribe service operation via NEF to subscribe the UE address change information of a specific PDU session of a 5G LAN VN or DN. The attributes of this service operation include the external group ID of the concerned 5G LAN VN or a DNN and a S-NSSAI, the UE address (e.g., IPv6 or MAC), the event to be subscribed (e.g., UE MAC address change), an existing-address indication to indicate if existing UE address information shall be returned so AF can build a full view of the UE address information of the specific PDU session of the 5G LAN VN or DN together with later UE address change information notify, the notification endpoint URI, and other attributes.

Step 1402: NEF receives the 5G_UE_AddrMonte_Subscribe service operation, and may interact with 5GC NFs. NEF sends a response back to AF. The response contains the subscription correlation ID to identify this subscription, and a list of UE address change information for existing UE address information of the specific PDU session of the 5G LAN VN or DN if existing-address indication is received in the subscription service operation. Alternatively, instead of returning existing UE address information in the response, NEF may send the existing UE address information via one or multiple 5G_UE_AddrMonte_Notify.

Step 1403: NEF may get the UE address change information of this specific PDU session connected to this 5G LAN VN or DN, and NEF sends the 5G_UE_AddrMonte_Notify service operation to the notification endpoint URI in the subscription service operation, with the event ID (e.g., UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address or existing address) are indicated.

Step 1404: AF sends a response of 5G_UE_AddrMonte_Notify to NEF.

FIG. 15 shows a flowchart of AF subscribes the UE address change of a group of UEs for a DN via a new API according to an embodiment of the present disclosure.

Step 1501: AF invokes 5G_UE_AddrMonte_Subscribe service operation via NEF to subscribe the UE address change information of a group of UEs for a DN. The attributes of this service operation include the external group ID of the group of UEs, a DNN and a S-NSSAI, the event to be subscribed (e.g., UE MAC address change), an existing-address indication to indicate if existing UE address information shall be returned so AF can build a full view of the UE address information of the group of UEs for the DN together with later UE address change information notify, the notification endpoint URI, and other attributes.

Step 1502: NEF receives the 5G_UE_AddrMonte_Subscribe service operation, and may interact with 5GC NFs. NEF sends a response back to AF. The response contains the subscription correlation ID to identify this subscription, and a list of UE address change information for the existing UE address information of the group of UEs for the DN if existing-address indication is received in the subscription service operation. Alternatively, instead of returning existing UE address information in the response, NEF may send the existing UE address information via one or multiple 5G_UE_AddrMonte_Notify.

Step 1503: NEF may get the UE address change information of the group of UEs for the DN, and NEF sends the 5G_UE_AddrMonte_Notify service operation to the notification endpoint URI in the subscription service operation, with the event ID (e.g., UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address or existing address) are indicated.

Step 1504: AF sends a response of 5G_UE_AddrMonte_Notify to NEF.

In another embodiment of 5G_LANVN_UE_AddrMonte API, another new event “UE in Use” (or other name, e.g. “UE Presence”) can be exposed to AF in the similar way as “UE MAC address change” event in above flowcharts of FIGS. 12-15. This event is reported to AF via 5G_UE_AddrMonte_Notify with following information:
Event ID
List of UE in use information
   UE ID (e.g. SUPI or GPSI)
   UE in use indication

If a UE is associated with at least one address, then the UE in use indication is “in use”, otherwise it is “not in use”.

In an embodiment, it can reuse and enhance existing Nnef_EventExposure API as described in 3GPP TS 29.122 V16.7.0 and 3GPP TS 23.502 V16.7.1. Nnef_EventExposure API can be enhanced to provide similar function of 5G_UE_AddrMonte API. Nnef_EventExposure_Subscribe operation as described in 3GPP TS 23.502 V16.7.1 can be enhanced to provide similar function of 5G_UE_AddrMonte_Subscription:
Reuse existing externalGroupId attribute in MonitoringEventSubscription data type for the concerned 5G LAN VN or the concerned UE(s) group.
Add a new DNN attribute and a S-NSSAI attribute in MonitoringEventSubscription data type for the concerned DN.
Reuse existing msisdn attribute and externalld attribute for the concerned UE(s) ID.
Reuse existing ipv4Addr attribute and ipv6Addr attribute in MonitoringEventSubscription data type and add a new macAddr attribute for the concerned UE(s) address.
Add new events in MonitoringType data type to allow the subscription from AF.
   Event 1-1: UE MAC address change
   Event 1-2: UE IP address change
      If only (existing) external group ID (externalGroupld attribute) or the new DNN attribute exists it indicates the subscription on UE address change of a 5G LAN VN (identified by the external group ID) or a DN (identified by DNN).
      If (existing) external group ID or the new DNN, and (existing) UE ID (msisdn attribute or externalld attribute) exist, it indicates the subscription on UE address change of a specific UE of a 5G LAN VN or a DN.
      If (existing) external group ID or the new DNN, and UE address (ipv4Addr or ipv6Addr or new macAddr) exist, it indicates the subscription on UE address change of a specific UE PDU session of a 5G LAN VN or a DN.
      If (existing) external group ID and the new DNN exist, it indicates the subscription on UE address change of a group of UEs (identified by external group ID) for a DN (identified by DNN).
Add a new existing-address indication in MonitoringEventSubscription data type, to indicate if the existing UE address information shall be returned or not.

The response of Nnef_EventExposure_Subscribe can be enhanced, to include a new list of UE address change information (as specified in 5G_UE_AddrMonte_Notify), to return the existing UE address information if existing-address indication is set in Nnef_EventExposure_Subscribe.

Nnef_EventExposure_Notify operation as described in 3GPP TS 23.502 V16.7.1 can be enhanced to support the function of 5G_UE_AddrMonte_Notify:
The Nnef_EventExposure_Notify is to be enhanced (in MonitoringEventReport data type) to include a new list of UE address change information as specified in 5G_UE_AddrMonte_Notify.

Nnef_EventExposure_Unsubscribe as described in 3GPP TS 23.502 V16.7.1 can be reused to support of function of 5G_UE_AddrMonte_API_Unsubscribe.

Nnef_EventExposure_Update (as defined in 3GPP TS 29.122 V16.7.0 Table 5.3.3.1-1: Resources and methods overview, by using PUT message) can be enhanced to support of function of 5G_UE_AddrMonte_Update.

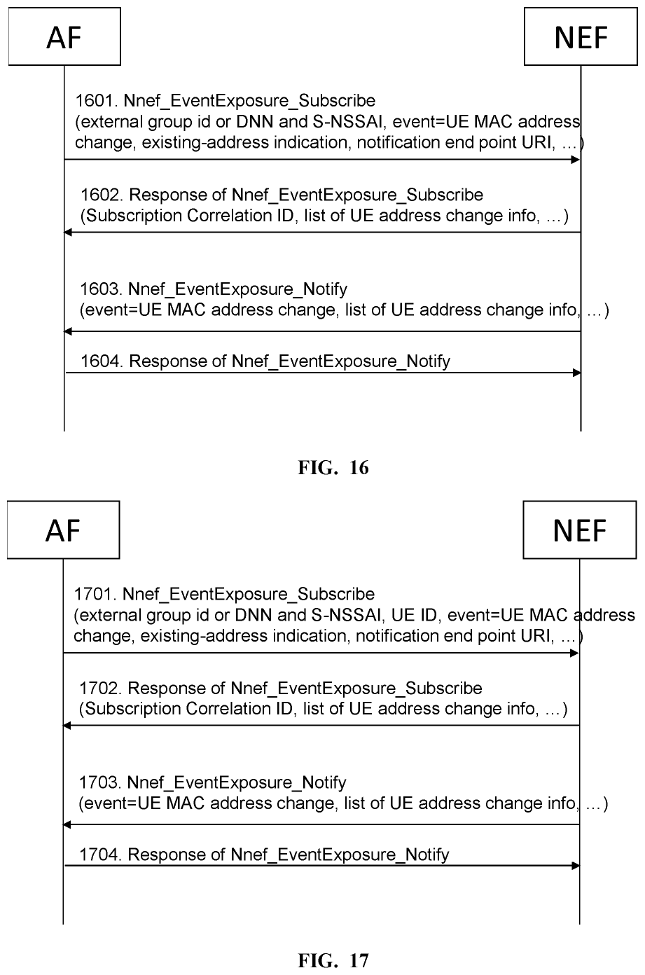

FIG. 16 shows a flowchart of AF subscribes the UE address change of a 5G LAN VN or DN via enhanced Nnef_EventExposure API according to an embodiment of the present disclosure.

Step 1601: AF invokes Nnef_EventExposure_Subscribe service operation via NEF to subscribe the UE address change information of a 5G LAN VN or DN. The attributes of this service operation include the external group ID of the concerned 5G LAN VN or a DNN and a S-NSSAI, the event to be subscribed (e.g., UE MAC address change), an existing-address indication to indicate if existing UE address information shall be returned so AF can build a full view of the UE address information of the 5G LAN VN or DN together with later UE address change information notify, the notification endpoint URI, and other attributes.

Step 1602: NEF receives the Nnef_EventExposure_Subscribe service operation, and may interact with 5GC NFs. NEF sends a response back to AF. The response contains the subscription correlation ID to identify this subscription, and a list of UE address change information for existing UE address information of the 5G LAN VN or DN if existing-address indication is received in the subscription service operation. Alternatively, instead of returning existing UE address information in the response, NEF may send the existing UE address information via one or multiple Nnef_EventExposure_Notify.

Step 1603: NEF may get the UE address change information of any UE connected to this 5G LAN VN or DN, and NEF sends the Nnef_EventExposure_Notify service operation to the notification endpoint URI in the subscription service operation with the event ID (e.g., UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address or existing address) are indicated.

Step 1604: AF sends a response of Nnef_EventExposure_Notify to NEF.

FIG. 17 shows a flowchart of AF subscribes the UE address change of a specific UE of a 5G LAN VN or a DN via enhanced Nnef_EventExposure API according to an embodiment of the present disclosure.

Step 1701: AF invokes Nnef_EventExposure_Subscribe service operation via NEF to subscribe the UE address change information of a specific UE of a 5G LAN VN or a DN. The attributes of this service operation include the external group ID of the concerned 5G LAN VN or a DNN and a S-NSSAI, the UE ID (e.g., GPSI or SUPI), the event to be subscribed (e.g., UE MAC address change), an existing-address indication to indicate if existing UE address information shall be returned so AF can build a full view of the UE address information of the specific UE for the 5G LAN VN or DN together with later UE address change information notify, the notification endpoint URI, and other attributes.

Step 1702: NEF receives the Nnef_EventExposure_Subscribe service operation, and may interact with 5GC NFs. NEF sends a response back to AF. The response contains the subscription correlation ID to identify this subscription, and a list of UE address change information for existing UE address information of the specific UE of the 5G LAN VN or DN if existing-address indication is received in the subscription service operation. Alternatively, instead of returning existing UE address information in the response, NEF may send the existing UE address information via one or multiple Nnef_EventExposure_Notify.

Step 1703: NEF may get the UE address change information of this specific UE connected to this 5G LAN VN or DN, and NEF sends the Nnef_EventExposure_Notify service operation to the notification endpoint URI in the subscription service operation with the event ID (e.g., UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address or existing address) are indicated.

Step 1704: AF sends a response of Nnef_EventExposure_Notify to NEF.

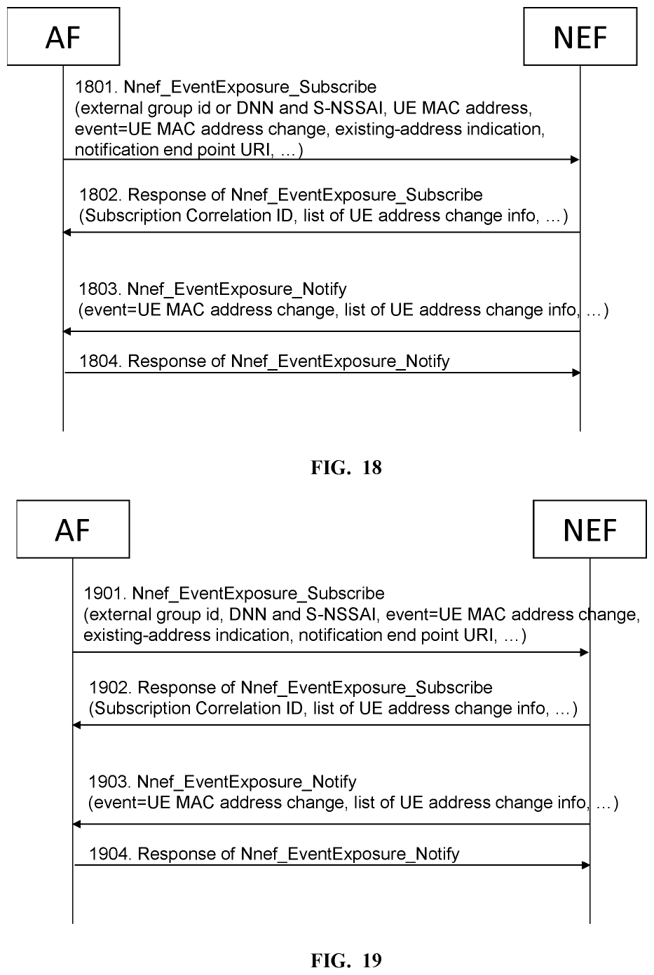

FIG. 18 shows a flowchart of AF subscribe the UE address change of a specific UE PDU session of a 5G LAN VN or a DN via enhanced Nnef_EventExposure API according to an embodiment of the present disclosure.

Step 1801: AF invokes Nnef_EventExposure_Subscribe service operation via NEF to subscribe the UE address change information of a specific PDU session of a 5G LAN VN or a DN. The attributes of this service operation include the external group ID of the concerned 5G LAN VN or a DNN and a S-NSSAI, the UE address (MAC address in this example), the event to be subscribed (e.g., UE MAC address change), an existing-address indication to indicate if existing UE address information shall be returned so AF can build a full view of the UE address information of the specific PDU session of the 5G LAN VN or DN together with later UE address change information notify, the notification endpoint URI, and other attributes.

Step 1802: NEF receives the Nnef_EventExposure_Subscribe service operation, and may interact with 5GC NFs. NEF sends a response back to AF. The response contains the subscription correlation ID to identify this subscription, and a list of UE address change information for the existing UE address of the specific PDU session of the 5G LAN VN or DN if existing-address indication is received in the subscription service operation. Alternatively, instead of returning existing UE address information in the response, NEF may send the existing UE address information via one or multiple Nnef_EventExposure_Notify.

Step 1803: NEF may get the UE address change information of this specific PDU session connected to this 5G LAN VN or DN, and NEF sends the Nnef_EventExposure_Notify service operation to the notification endpoint URI in the subscription service operation, with the event ID (e.g., UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address or existing address) are indicated.

Step 1804: AF sends a response of Nnef_EventExposure_Notify to NEF.

FIG. 19 shows a flowchart of AF subscribe the UE address change of a group of UEs for a DN via enhanced Nnef_EventExposure API according to an embodiment of the present disclosure.

Step 1901: AF invokes Nnef_EventExposure_Subscribe service operation via NEF to subscribe the UE address change information of a group of UEs for a DN. The attributes of this service operation include the external group ID of the concerned group of UEs, a DNN and a S-NSSAI, the event to be subscribed (e.g., UE MAC address change), an existing-address indication to indicate if existing UE address information shall be returned so AF can build a full view of the UE address information of the concerned group of UEs for a DN together with later UE address change information notify, the notification endpoint URI, and other attributes.

Step 1902: NEF receives the Nnef_EventExposure_Subscribe service operation, and may interact with 5GC NFs. NEF sends a response back to AF. The response contains the subscription correlation ID to identify this subscription, and a list of UE address change information for existing UE address information of the concerned group of UEs if existing-address indication is received in the subscription service operation. Alternatively, instead of returning existing UE address information in the response, NEF may send the existing UE address information via one or multiple Nnef_EventExposure_Notify.

Step 1903: NEF may get the UE address change information of the group of UEs for the DN, and NEF sends the Nnef_EventExposure_Notify service operation to the notification endpoint URI in the subscription service operation, with the event ID (e.g., UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address or existing address) are indicated.

Step 1904: AF sends a response of Nnef_EventExposure_Notify to NEF.

In another embodiment of Nnef_EventExposure API, another new event “UE in Use” (or other name, e.g. “UE Presence”) can be exposed to AF in the similar way as “UE MAC address change” event in above flowcharts of FIGS. 16-19. This event is reported to AF via Nnef_EventExposure_Notify with following information:
Event ID
List of UE in use information
   UE ID (e.g. SUPI or GPSI)
   UE in use indication

If a UE is associated with at least one address then the UE in use indication is “in use”, otherwise it is “not in use”.

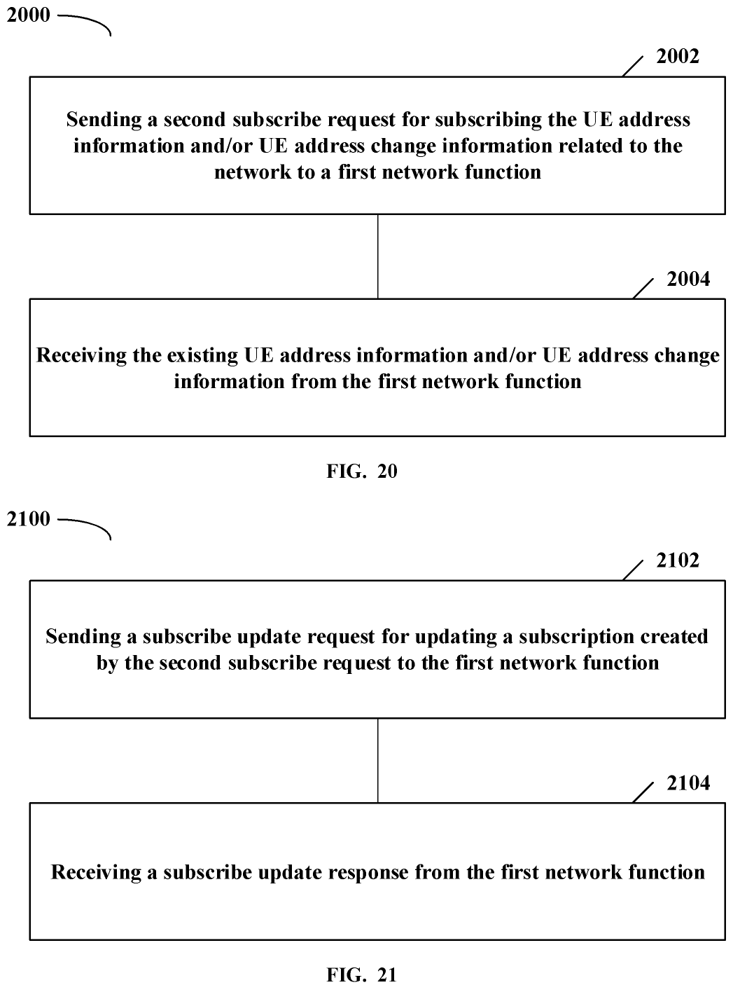

FIG. 20 shows a flowchart 2000 of obtaining the existing UE address information and/or UE address change information related to the network according to an embodiment of the present disclosure. For some parts which have been described in the above embodiments, the description thereof is omitted here for brevity.

At step 2002, the exposure function sends a second subscribe request for subscribing the UE address information and/or UE address change information related to the network to a first network function.

The network function may be any suitable network function which may store or can retrieve the existing UE address information and/or UE address change information from another network function. In an embodiment, the network function comprises at least one of a session management function, a binding support function, or a policy control function.

At step 2004, the exposure function receives the existing UE address information and/or UE address change information from the first network function.

FIG. 21 shows a flowchart of a method 2100 according to another embodiment of the present disclosure. For some parts which have been described in the above embodiments, the description thereof is omitted here for brevity.

At step 2102, the exposure function sends a subscribe update request for updating a subscription created by the second subscribe request to the first network function. For example, the subscribe update request may comprise a subscription correlation ID and attribute(s) to be updated (e.g., modified or added or deleted), e.g. parameters (such as reporting control information, reporting filter information, etc.) comprised in the second subscribe request. The first network function may perform a subscribe update operation and generate a subscribe update operation execution result indication.

At step 2104, the exposure function receive a subscribe update response from the first network function. The subscribe update response may comprise a subscribe update operation execution result indication.

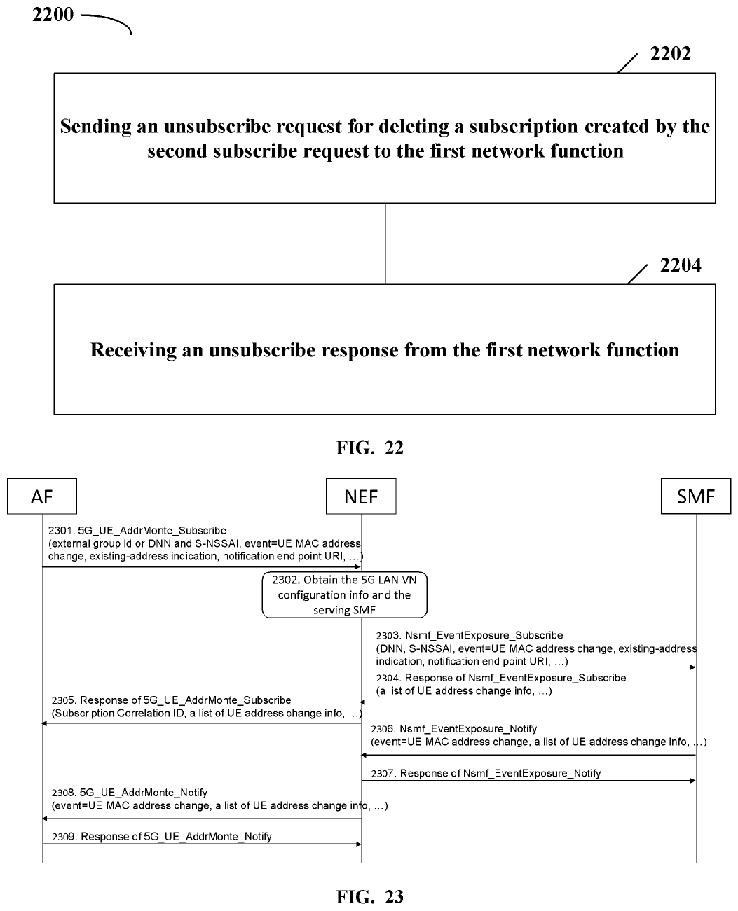

FIG. 22 shows a flowchart of a method 2200 according to another embodiment of the present disclosure. For some parts which have been described in the above embodiments, the description thereof is omitted here for brevity.

At step 2202, the exposure function sends an unsubscribe request for deleting a subscription created by the second subscribe request to the first network function. For example, the unsubscribe request may comprise a subscription correlation ID. The first network function may perform an unsubscribe operation and generate an unsubscribe operation execution result indication.

At step 2204, the exposure function receive an unsubscribe response from the first network function. The unsubscribe response may comprise an unsubscribe operation execution result indication.

In an embodiment, the second subscribe request comprises an identifier of the network.

In an embodiment, the second subscribe request comprises an identifier of the network and a UE identifier.

In an embodiment, the second subscribe request comprises an identifier of the network and an address of a UE.

In an embodiment, the second subscribe request comprises an identifier of the network and a group identifier.

In an embodiment, the second subscribe request comprises at least one of single network slice selection assistance information (S-NSSAI), an indication of UE MAC address change event to be subscribed, an indication of UE IP address change event to be subscribed, an indication of whether existing UE address information shall be returned, a uniform resource identifier (URI) of a notification endpoint, reporting control information, a reporting filter.

In an embodiment, the existing UE address information is received in a second subscribe response or at least one event exposure notification message.

In an embodiment, the UE address change information is received in an event exposure notification message.

In an embodiment, the NEF can get the UE address information of a 5G LAN VN or DN from other 5GC NFs. For example, the NEF can get the UE address information of a 5G LAN VN or DN via the SMF that is dedicated to serve a 5G LAN VN.

In an embodiment, NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get as described in 3GPP TS 23.502 V16.7.1 to get the 5GVnGroupConfiguration of concerned 5G LAN VN. NEF gets the internal group ID, PDU session type, DNN and S-NSSAI of corresponding 5G LAN VN from 5GVnGroupConfiguration.

In an embodiment, NEF discovers the SMF that is dedicated to serve concerned 5G LAN VN by querying NRF, using DNN and S-NSSAI as query parameter.

In an embodiment, NEF invokes enhanced Nsmf_EventExposure API as described in 3GPP TS 29.508 V17.1.0, the disclosure of which is incorporated by reference herein in its entirety, to subscribe and/or get the UE address change information of the 5G LAN VN.

In an embodiment, if NEF gets the DNN (and optionally a corresponding S-NSSAI) information from AF, then NEF discovers the SMF(s) that serves the DN by querying NRF, using DNN and S-NSSAI as query parameter. Then NEF invokes enhanced Nsmf_EventExposure API for each SMF serving the DN to subscribe and/or get the UE address change information of the DN.

In an embodiment, Nsmf_EventExposure API needs to be enhanced.

In an embodiment, Nsmf_EventExposure_Subscribe operation is enhanced to:
Support a new event for UE MAC address change
   Event 2: UE MAC address change (UE_MAC_CH)
Note: UE IP address change event (UE_IP_CH) is already supported in Nsmf_EventExposure.
Support a new existing-address indication for the new Event 2 (UE_MAC_CH) and existing UE_IP_CH event subscription, to indicate if the existing UE address information shall be returned.
Support a new UE address (IP and/or MAC) attribute to indicate the address of corresponding UE PDU session.

In an embodiment, if only (existing) DNN (and optionally S-NSSAI, i.e. the dnn attribute and snssai attribute) exists, it indicates the subscription on all UE address change of a 5G LAN VN or DN.

In an embodiment, if (existing) DNN (and optionally S-NSSAI) and (existing) UE ID (i.e., the supi attribute and gpsi attribute) exist, it indicates the subscription on UE address change of a specific UE of a 5G LAN VN or DN.

In an embodiment, if (existing) DNN (and optionally S-NSSAI) and the new UE address attribute exist, it indicates the subscription on the specific UE PDU session of a 5G LAN VN or DN.

In an embodiment, if (existing) DNN (and optionally S-NSSAI) and the (existing) group of UEs (i.e., the groupId attribute) exist, it indicates the subscription on the group of UEs for a DN.

In an embodiment, the response of Nsmf_EventExposure_Subscribe is to be enhanced, to include a new list of UE address change information (as specified in 5G_UE_AddrMonte_Notify) to return the existing UE address information if existing-address indication is set in Nsmf_EventExposure_Subscribe.

In an embodiment, Nsmf_EventExposure_Notify operation is to be enhanced:
EventNotification data type is enhanced to include a new list of UE address change information (as specified in 5G_UE_AddrMonte_Notify).

FIG. 23 shows a flowchart of AF subscribes the UE address change of a 5G LAN VN or DN via a new API and NEF collects UE address change information from SMF(s) according to an embodiment of the present disclosure. For some parts which have been described in the above embodiments, the description thereof is omitted here for brevity.

Step 2301: AF invokes 5G_UE_AddrMonte_Subscribe service operation via NEF to subscribe the UE address change information of a 5G LAN VN or a DN. The attributes of this service operation include the external group ID of the concerned 5G LAN VN or a DNN and a S-NSSAI, the event to be subscribed (e.g., UE MAC address change), an existing-address indication to indicate if existing UE address information shall be returned so AF can build a full view of the UE address information of the 5G LAN VN or DN together with later UE address change information notify, the notification endpoint URI, and other attributes.

Step 2302: NEF receives the 5G_UE_AddrMonte_Subscribe service operation and obtains the 5G LAN VN configuration information and corresponding dedicated serving SMF if need.

In an embodiment, NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get to get the 5GVnGroupConfiguration of concerned 5G LAN VN. NEF gets the internal group ID, PDU session type, DNN and S-NSSAI of corresponding 5G LAN VN from 5GVnGroupConfiguration.

In an embodiment, NEF discovers the SMF that is dedicated to serve concerned 5G LAN VN by querying NRF, using DNN and S-NSSAI as query parameter.

In another embodiment, if NEF gets the DNN (and optionally a corresponding S-NSSAI) information from AF, then NEF discovers the SMF(s) that serves the DN by querying NRF, using DNN and S-NSSAI as query parameter. Then NEF invokes enhanced Nsmf_EventExposure API (step 2303) for each SMF serving the DN to subscribe and/or get the UE address change information of the DN.

Step 2303: NEF invokes the Nsmf_EventExposure_Subscription service operation, with the DNN (and S-NSSAI) obtained in step 2302, event to be subscribed (based on the event information from AF in step 2301), the existing-address indication obtained from step 2301, and other attributes.

Step 2304: NEF receives the successful response from SMF, with a list of UE address change information for existing UE address information of the concerned 5G LAN VN or DN.

Step 2305: NEF sends the response back to AF. The response contains the subscription correlation ID to identify this subscription, and a list of UE address change information for existing UE address information of the 5G LAN VN or DN if existing-address indication is received in the subscription service operation. Alternatively, instead of returning existing UE address information in the response, NEF may send the existing UE address information via one or multiple 5G_UE_AddrMonte_Notify.

Step 2306: SMF detects any UE address change of the 5G LAN VN or DN and sends Nsmf_EventExposure_Notify to NEF with the event ID (UE MAC change in this example), and a list of UE address change information.

Step 2307: NEF responds SMF on the receipt of the notify.

Step 2308: NEF sends the 5G_UE_AddrMonte_Notify service operation to the notification endpoint URI in the subscription service operation with the event ID (UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address or existing address) are indicated.

Step 2309: AF responds NEF on the receipt of the notify.

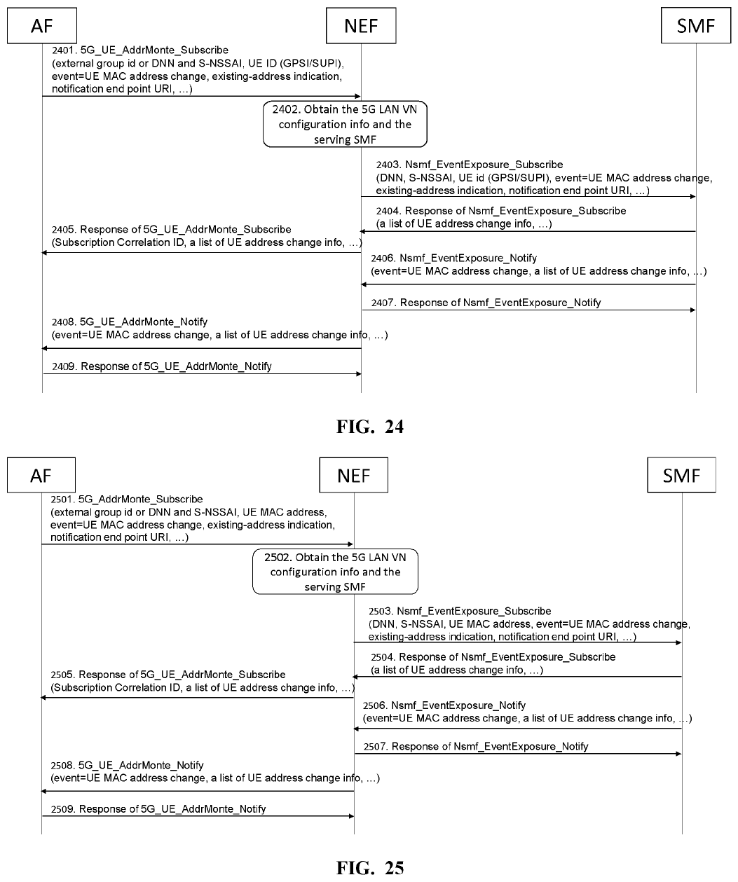

FIG. 24 shows a flowchart of AF subscribes the UE address change of a specific UE of the 5G LAN VN or DN via a new API and NEF collects UE address change information from SMF according to an embodiment of the present disclosure. For some parts which have been described in the above embodiments, the description thereof is omitted here for brevity.

Step 2401: AF invokes 5G_UE_AddrMonte_Subscribe service operation via NEF to subscribe the UE address change information of a specific UE of a 5G LAN VN or DN. The attributes of this service operation include the external group ID of the concerned 5G LAN VN or a DNN and S-NSSAI, the UE ID (GPSI/SUPI) of the concerned UE(s), the event to be subscribed (e.g., UE MAC address change), an existing-address indication to indicate if existing UE address information shall be returned so AF can build a full view of the UE address information of the specific UE of 5G LAN VN or DN together with later UE address change information notify, the notification endpoint URI, and other attributes.

Step 2402: NEF receives the 5G_UE_AddrMonte_Subscribe service operation and obtains the 5G LAN VN configuration information and corresponding dedicated serving SMF if need.

In an embodiment, NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get to get the 5GVnGroupConfiguration of concerned 5G LAN VN. NEF gets the internal group ID, PDU session type, DNN and S-NSSAI of corresponding 5G LAN VN from 5GVnGroupConfiguration.

In an embodiment, NEF discovers the SMF that is dedicated to serve concerned 5G LAN VN by querying NRF, using DNN and S-NSSAI as query parameter.

In an embodiment, if NEF gets the DNN (and optionally a corresponding S-NSSAI) information from AF, then NEF discovers the SMF(s) that serves the DN by querying NRF, using DNN and S-NSSAI as query parameter. Then NEF invokes enhanced Nsmf_EventExposure API (step 2403) for each SMF serving the DN to subscribe and/or get the UE address change information of the specific UE for the DN.

Step 2403: NEF invokes the Nsmf_EventExposure_Subscription service operation, with the DNN (and S-NSSAI) obtained in step 2402, UE ID obtained in step 2401, event ID is set (based on the event information from AF in step 2401, UE MAC address change as example), the existing-address indication obtained from step 1, and other attributes.

Step 2404: NEF receives the successful response from SMF, with a list of UE address change information for existing UE address information of the concerned UE(s).

Step 2405: NEF sends the response back to AF. The response contains the subscription correlation ID to identify this subscription, and a list of UE address change information for the existing UE address information of the specific UE if existing-address indication is received in the subscription service operation. Alternatively, instead of returning existing UE address information in the response, NEF may send the existing UE address information via one or multiple 5G_UE_AddrMonte_Notify.

Step 2406: SMF detects address change of the specific UE of the 5G LAN VN or DN, and sends Nsmf_EventExposure_Notify to NEF with the event ID (UE MAC address change in this example), and a list of UE address change information.

Step 2407: NEF responds SMF on the receipt of the notify.

Step 2408: NEF sends the 5G_UE_AddrMonte_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 2409: AF responds NEF on the receipt of the notify.

FIG. 25 shows a flowchart of AF subscribes the UE address change of a specific PDU session of the 5G LAN VN or DN via a new API and NEF collects UE address change information from SMF according to an embodiment of the present disclosure. For some parts which have been described in the above embodiments, the description thereof is omitted here for brevity.

Step 2501: AF invokes 5G_UE_AddrMonte_Subscribe service operation via NEF to subscribe the UE address change information of a specific PDU session of a 5G LAN VN or DN. The attributes of this service operation include the external group ID of the concerned 5G LAN VN or a DNN and a S-NSSAI, the UE address of the concerned UE(s) (MAC address in this example), the event to be subscribed (e.g., UE MAC address change), an existing-address indication to indicate if existing UE address information shall be returned so AF can build a full view of the UE address information of the specific PDU session of 5G LAN VN or DN together with later UE address change information notify, the notification endpoint URI, and other attributes. It is not applicable for the case where UE address is IPv4.

Step 2502: NEF receives the 5G_UE_AddrMonte_Subscribe service operation and obtains the 5G LAN VN configuration information and corresponding dedicated serving SMF.

In an embodiment, NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get to get the 5GVnGroupConfiguration of concerned 5G LAN VN. NEF gets the internal group ID, PDU session type, DNN and S-NSSAI of corresponding 5G LAN VN from 5GVnGroupConfiguration.

In an embodiment, NEF discovers the SMF that is dedicated to serve concerned 5G LAN VN by querying NRF, using DNN and S-NSSAI as query parameter.

In an embodiment, if NEF gets the DNN (and optionally a corresponding S-NSSAI) information from AF, then NEF discovers the SMF(s) that serves the DN by querying NRF, using DNN and S-NSSAI as query parameter. Then NEF invokes enhanced Nsmf_EventExposure API (step 2503) for each SMF serving the DN to subscribe and/or get the UE address change information of a specific PDU session.

Step 2503: NEF invokes the Nsmf_EventExposure_Subscription service operation, with the DNN (and S-NSSAI) obtained in step 2502, UE address obtained in step 2501, event ID is set based on the event information received from AF (UE MAC address change as example), the existing-address indication obtained from step 2501, and other attributes.

Step 2504: NEF receives the successful response from SMF, with a list of UE address change information for existing UE address information of the concerned UE(s) PDU session.

Step 2505: NEF sends the response back to AF. The response contains the subscription correlation ID to identify this subscription, and a list of UE address change information for existing UE address information of the specific PDU session if existing-address indication is received in the subscription service operation. Alternatively, instead of returning existing UE address information in the response, NEF may send the existing UE address information via one or multiple 5G_UE_AddrMonte_Notify.

Step 2506: SMF detects address change of the specific PDU session of the 5G LAN VN or DN, and sends Nsmf_EventExposure_Notify to NEF with the event ID (UE MAC address change in this example), and a list of UE address change information.

Step 2507: NEF responds SMF on the receipt of the notify.

Step 2508: NEF sends the 5G_UE_AddrMonte_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 2509: AF responds NEF on the receipt of the notify.

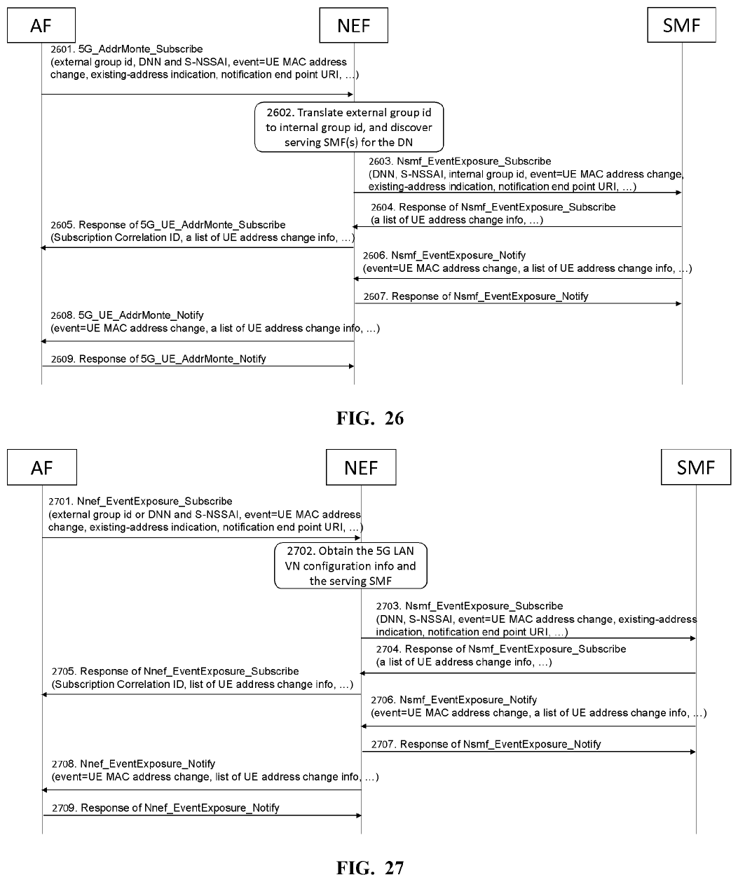

FIG. 26 shows a flowchart of AF subscribes the UE address change of a group of UEs for a DN via a new API and NEF collects UE address change information from SMF according to an embodiment of the present disclosure. For some parts which have been described in the above embodiments, the description thereof is omitted here for brevity.

Step 2601: AF invokes 5G_UE_AddrMonte_Subscribe service operation via NEF to subscribe the UE address change information of a group of UEs for a DN. The attributes of this service operation include the external group ID of the concerned group of UEs, a DNN and a S-NSSAI, the event to be subscribed (e.g., UE MAC address change), an existing-address indication to indicate if existing UE address information shall be returned so AF can build a full view of the UE address information together with later UE address change information notify, the notification endpoint URI, and other attributes.

Step 2602: NEF receives the 5G_UE_AddrMonte_Subscribe service operation and translates external group ID to internal group ID, and discovers serving SMF(s) for the DN.

In an embodiment, NEF discovers the UDM which hosts the corresponding external group ID via NRF discovery, by using external group ID as query parameter.

In an embodiment, NEF uses the Nudm_SubscriberDataManagement API (as defined in 3GPP TS 29.503 V17.1.0) to translate the external group ID to internal group ID.

In an embodiment, NEF discovers the SMF(s) that serves the DN by querying NRF, using DNN and S-NSSAI as query parameter. Then NEF invokes enhanced Nsmf_EventExposure API (step 2603) for each SMF serving the DN to subscribe and/or get the UE address change information.

Step 2603: NEF invokes the Nsmf_EventExposure_Subscription service operation, with the DNN (and S-NSSAI) obtained in step 2602, internal group ID obtained in step 2602, event ID is set based on the event information received from AF (UE MAC address change as example), the existing-address indication obtained from step 2601, and other attributes.

Step 2604: NEF receives the successful response from SMF, with a list of UE address change information for existing UE address information of the concerned group of UEs if existing-address indication is set in the Nsmf_EventExposure_Subscription.

Step 2605: NEF sends the response back to AF. The response contains the subscription correlation ID to identify this subscription, and a list of UE address change information for existing UE address information of the concerned group of UEs if existing-address indication is received in the subscription service operation. Alternatively, instead of returning existing UE address information in the response, NEF may send the existing UE address information via one or multiple 5G_UE_AddrMonte_Notify.

Step 2606: SMF detects address change of the concerned group of UEs for the DN and sends Nsmf_EventExposure_Notify to NEF with the event ID (UE MAC address change in this example), and a list of UE address change information.

Step 2607: NEF responds SMF on the receipt of the notify.

Step 2608: NEF sends the 5G_UE_AddrMonte_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 2609: AF responds NEF on the receipt of the notify.

FIG. 27 shows a flowchart of AF subscribes the UE address change of a 5G LAN VN or DN via an existing API and NEF collects UE address change information from SMF(s) according to an embodiment of the present disclosure. For some parts which have been described in the above embodiments, the description thereof is omitted here for brevity.

Step 2701: AF invokes Nnef_EventExposure_Subscribe service operation via NEF to subscribe the UE address change information of a 5G LAN VN or DN. The attributes of this service operation include the external group ID of the concerned 5G LAN VN or a DNN and a S-NSSAI, the event to be subscribed (e.g., UE MAC address change), an existing-address indication to indicate if existing UE address information shall be returned so AF can build a full view of the UE address information of the 5G LAN VN or DN together with later UE address change information notify, the notification endpoint URI, and other attributes.

Step 2702: NEF receives the Nnef_EventExposure_Subscribe service operation and obtains the 5G LAN VN configuration information and corresponding dedicated serving SMF if need.

In an embodiment, NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get to get the 5GVnGroupConfiguration of concerned 5G LAN VN. NEF gets the internal group ID, PDU session type, DNN and S-NSSAI of corresponding 5G LAN VN from 5GVnGroupConfiguration.

In an embodiment, NEF discovers the SMF that is dedicated to serve concerned 5G LAN VN by querying NRF, using DNN and S-NSSAI as query parameter.

In an embodiment, if NEF gets the DNN (and optionally a corresponding S-NSSAI) information from AF, then NEF discovers the SMF(s) that serves the DN by querying NRF, using DNN and S-NSSAI as query parameter. Then NEF invokes enhanced Nsmf_EventExposure API (step 2703) for each SMF serving the DN to subscribe and/or get the UE address change information of the DN.

Step 2703: NEF invokes the Nsmf_EventExposure_Subscription service operation, with the DNN (and S-NSSAI) obtained in step 2702, event to be subscribed (based on the event information from AF in step 2701), the existing-address indication obtained from step 2701, and other attributes.

Step 2704: NEF receives the successful response from SMF, with a list of UE address change information for existing UE address information of the concerned 5G LAN VN or DN if existing-address indication is set in the Nsmf_EventExposure_Subscription.

Step 2705: NEF sends the response back to AF. The response contains the subscription correlation ID to identify this subscription, and a list of UE address change information for existing UE address information of the 5G LAN VN or DN if existing-address indication is received in the subscription service operation. Alternatively, instead of returning existing UE address information in the response, NEF may send the existing UE address information via one or multiple Nnef_EventExposure_Notify.

Step 2706: SMF detects UE address change of the 5G LAN VN or DN and sends Nsmf_EventExposure_Notify to NEF with the event ID (UE MAC change in this example), and a list of UE address change information.

Step 2707: NEF responds SMF on the receipt of the notify.

Step 2708: NEF sends the Nnef_EventExposure_Notify service operation to the notification endpoint URI in the subscription service operation with the event ID (UE MAC address change), a list of UE address change information and other attributes to AF. Each UE address change information contains the UE ID (e.g., GPSI, or SUPI) of the concerned UE(s), and a list of UE address information wherein the UE address(es) and UE address change type (new address, obsoleted address, or existing address) are indicated.

Step 2709: AF responds NEF on the receipt of the notify.

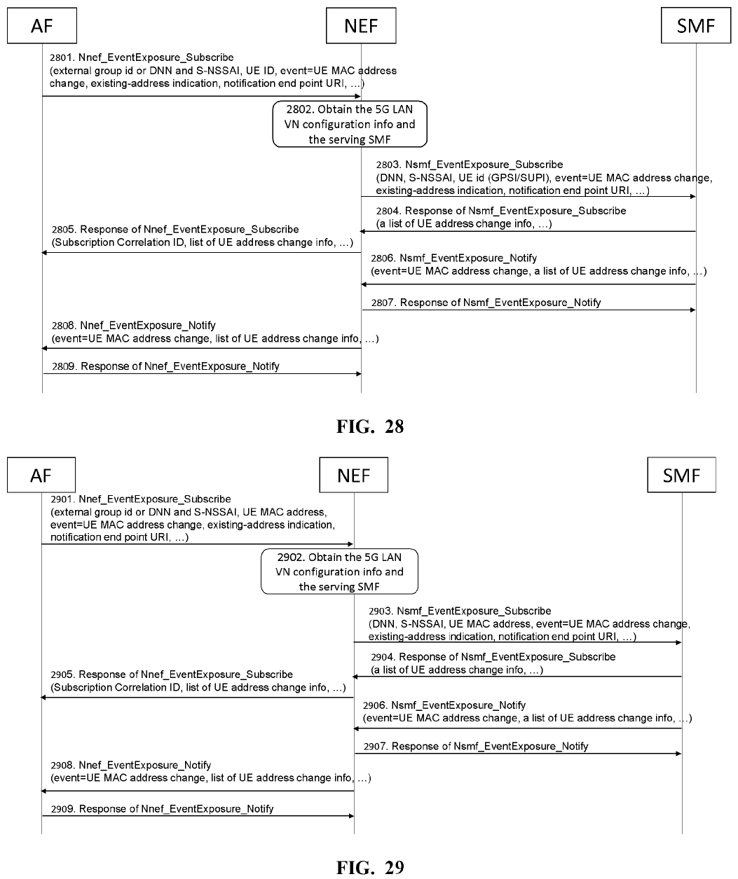

FIG. 28 shows a flowchart of AF subscribes the UE address change of a specific UE of the 5G LAN VN or DN via an existing API and NEF collects UE address change information from SMF according to an embodiment of the present disclosure. For some parts which have been described in the above embodiments, the description thereof is omitted here for brevity.

Step 2801: AF invokes Nnef_EventExposure_Subscribe service operation via NEF to subscribe the UE address change information of a specific UE of a 5G LAN VN or DN. The attributes of this service operation include the external group ID of the concerned 5G LAN VN or a DNN and a S-NSSAI, the UE ID (GPSI/SUPI) of the concerned UE(s), the event to be subscribed (e.g., UE MAC address change), an existing-address indication to indicate if existing UE address information shall be returned so AF can build a full view of the UE address information of the specific UE of 5G LAN VN or DN together with later UE address change information notify, the notification endpoint URI, and other attributes.

Step 2802: NEF receives the Nnef_EventExposure_Subscribe service operation and obtains the 5G LAN VN configuration information and corresponding dedicated serving SMF if need.

In an embodiment, NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get to get the 5GVnGroupConfiguration of concerned 5G LAN VN. NEF gets the internal group ID, PDU session type, DNN and S-NSSAI of corresponding 5G LAN VN from 5GVnGroupConfiguration.

In an embodiment, NEF discovers the SMF that is dedicated to serve concerned 5G LAN VN by querying NRF, using DNN and S-NSSAI as query parameter.

In an embodiment, if NEF gets the DNN (and optionally a corresponding S-NSSAI) information from AF, then NEF discovers the SMF(s) that serves the DN by querying NRF, using DNN and S-NSSAI as query parameter. Then NEF invokes enhanced Nsmf_EventExposure API (step 2803) for each SMF serving the DN to subscribe and/or get the UE address change information of the specific UE for the DN.

Step 2803: NEF invokes the Nsmf_EventExposure_Subscription service operation, with the DNN (and S-NSSAI) obtained in step 2802, UE ID obtained in step 2801, event ID is set (based on the event information from AF in step 2801, UE MAC address change as example), the existing-address indication obtained from step 2801, and other attributes.

Step 2804: NEF receives the successful response from SMF, with a list of HE address change information for existing HE address information of the concerned UE(s) if existing-address indication is set in the Nsmf_EventExposure_Subscription.

Step 2805: NEF sends the response back to AF. The response contains the subscription correlation ID to identify this subscription, and a list of UE address change information for the existing UE address information of the specific UE if existing-address indication is received in the subscription service operation. Alternatively, instead of returning existing UE address information in the response, NEF may send the existing UE address information via one or multiple Nnef_EventExposure_Notify.

Step 2806: SMF detects address change of the specific UE of the 5G LAN VN or DN and sends Nsmf_EventExposure_Notify to NEF with the event ID (UE MAC address change in this example), and a list of UE address change information.

Step 2807: NEF responds SMF on the receipt of the notify.

Step 2808: NEF sends the Nnef_EventExposure_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 2809: AF responds NEF on the receipt of the notify.

FIG. 29 shows a flowchart of AF subscribes the UE address change of a specific PDU session of the 5G LAN VN or DN via an existing API and NEF collects UE address change information from SMF according to an embodiment of the present disclosure. For some parts which have been described in the above embodiments, the description thereof is omitted here for brevity.

Step 2901: AF invokes Nnef_EventExposure_Subscribe service operation via NEF to subscribe the UE address change information of a specific PDU session of a 5G LAN VN or DN. The attributes of this service operation include the external group ID of the concerned 5G LAN VN or a DNN and a S-NSSAI, the UE address of the concerned UE(s) (MAC address in this example), the event to be subscribed (e.g., UE MAC address change), an existing-address indication to indicate if existing UE address information shall be returned so AF can build a full view of the UE address information of the specific PDU session of the 5G LAN VN or DN together with later UE address change information notify, the notification endpoint URI, and other attributes. It is not applicable for the case where the UE address is IPv4.

Step 2902: NEF receives the Nnef_EventExposure_Subscribe service operation and obtains the 5G LAN VN configuration information and corresponding dedicated serving SMF.

In an embodiment, NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get to get the 5GVnGroupConfiguration of concerned 5G LAN VN. NEF gets the internal group ID, PDU session type, DNN and S-NSSAI of corresponding 5G LAN VN from 5GVnGroupConfiguration.

In an embodiment, NEF discovers the SMF that is dedicated to serve concerned 5G LAN VN by querying NRF, using DNN and S-NSSAI as query parameter.

In an embodiment, if NEF gets the DNN (and optionally a corresponding S-NSSAI) information from AF, then NEF discovers the SMF(s) that serves the DN by querying NRF, using DNN and S-NSSAI as query parameter. Then NEF invokes enhanced Nsmf_EventExposure API (step 2903) for each SMF serving the DN to subscribe and/or get the UE address change information of a specific PDU session.

Step 2903: NEF invokes the Nsmf_EventExposure_Subscription service operation, with the DNN (and S-NSSAI) obtained in step 2902, UE address obtained in step 2901, event ID is set based on the event information received from AF (UE MAC address change as example), the existing-address indication obtained from step 2901, and other attributes.

Step 2904: NEF receives the successful response from SMF, with a list of UE address change information for existing UE address information of the concerned UE(s) PDU session is existing-address indication is set in the Nsmf_EventExposure_Subscription.

Step 2905: NEF sends the response back to AF. The response contains the subscription correlation ID to identify this subscription, and a list of UE address change information for existing UE address information of the specific PDU session if existing-address indication is received in the subscription service operation. Alternatively, instead of returning existing UE address information in the response, NEF may send the existing UE address information via one or multiple Nnef_EventExposure_Notify.

Step 2906: SMF detects address change of the specific PDU session of the 5G LAN VN or DN and sends Nsmf_EventExposure_Notify to NEF with the event ID (UE MAC address change in this example), and a list of UE address change information.

Step 2907: NEF responds SMF on the receipt of the notify.

Step 2908: NEF sends the Nnef_EventExposure_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 2909: AF responds NEF on the receipt of the notify.

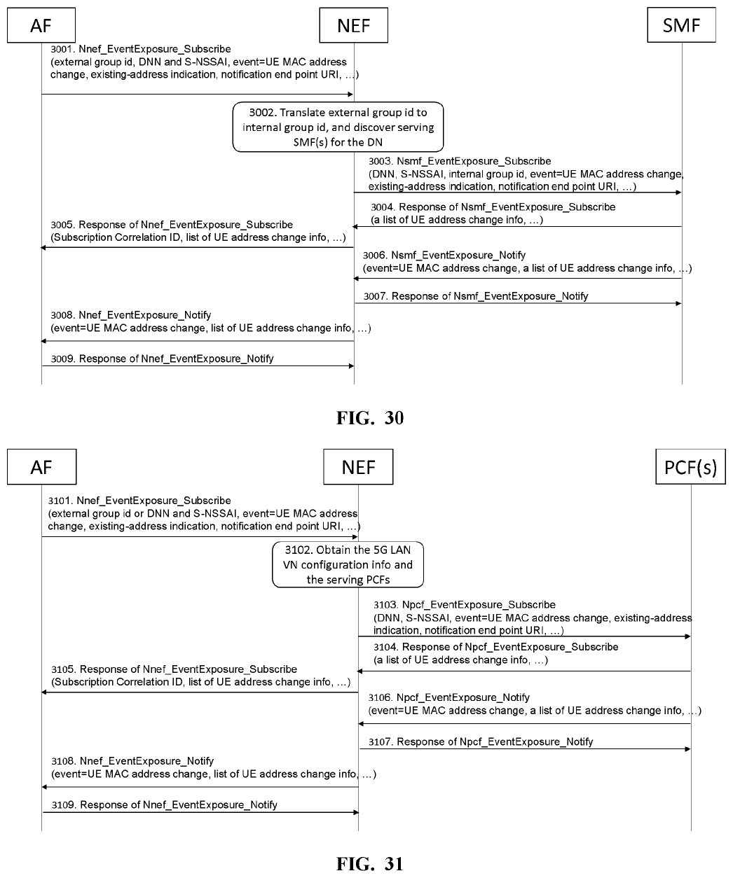

FIG. 30 shows a flowchart of AF subscribes the UE address change of a group of UEs for a DN via an existing API and NEF collects UE address change information from SMF according to an embodiment of the present disclosure. For some parts which have been described in the above embodiments, the description thereof is omitted here for brevity.

Step 3001: AF invokes Nnef_EventExposure_Subscribe service operation via NEF to subscribe the UE address change information of a group of UEs for a DN. The attributes of this service operation include the external group ID of the concerned group of UEs, a DNN and a S-NSSAI, the event to be subscribed (e.g., UE MAC address change), an existing-address indication to indicate if existing UE address information shall be returned so AF can build a full view of the UE address information together with later UE address change information notify, the notification endpoint URI, and other attributes.

Step 3002: NEF receives the Nnef_EventExposure_Subscribe service operation and translates external group ID to internal group ID, and discovers serving SMF(s) for the DN.

In an embodiment, NEF discovers the UDM which hosts the corresponding external group ID via NRF discovery, by using external group ID as query parameter.

In an embodiment, NEF uses the Nudm_SubscriberDataManagement API (as defined in 3GPP TS 29.503 V17.1.0) to translate the external group ID to internal group ID.

In an embodiment, NEF discovers the SMF(s) that serves the DN by querying NRF, using DNN and S-NSSAI as query parameter. Then NEF invokes enhanced Nsmf_EventExposure API (step 3003) for each SMF serving the DN to subscribe and/or get the UE address change information.

Step 3003: NEF invokes the Nsmf_EventExposure_Subscription service operation, with the DNN (and S-NSSAI) obtained in step 3002, internal group ID obtained in step 3002, event ID is set based on the event information received from AF (UE MAC address change as example), the existing-address indication obtained from step 3001, and other attributes.

Step 3004: NEF receives the successful response from SMF, with a list of UE address change information for existing UE address information of the concerned group of UEs if existing-address indication is set in Nsmf_EventExposure_Subscription.

Step 3005: NEF sends the response back to AF. The response contains the subscription correlation ID to identify this subscription, and a list of UE address change information for existing UE address information of the concerned group of UEs if existing-address indication is received in the subscription service operation. Alternatively, instead of returning existing UE address information in the response, NEF may send the existing UE address information via one or multiple Nnef_EventExposure_Notify.

Step 3006: SMF detects address change of the concerned group of UEs for a DN and sends Nsmf_EventExposure_Notify to NEF with the event ID (UE MAC address change in this example), and a list of UE address change information.

Step 3007: NEF responds SMF on the receipt of the notify.

Step 3008: NEF sends the Nnef_EventExposure_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 3009: AF responds NEF on the receipt of the notify.

In an embodiment, NEF may communicate with PCFs directly via enhanced Npcf_EventExposure API to obtain the existing UE address information and/or UE address change information related to the network.

FIG. 31 shows a flowchart of AF subscribes the UE address change of a 5G LAN VN or DN via an existing API and NEF collects UE address change information directly from PCF(s) according to an embodiment of the present disclosure. For some parts which have been described in the above embodiments, the description thereof is omitted here for brevity.

Step 3101: AF invokes Nnef_EventExposure_Subscribe service operation via NEF to subscribe the UE address change information of a 5G LAN VN or DN. The attributes of this service operation include the external group ID of the concerned 5G LAN VN or a DNN and a S-NSSAI, the event to be subscribed (e.g., UE MAC address change), an existing-address indication to indicate if existing UE address information shall be returned so AF can build a full view of the UE address information of the 5G LAN VN or DN together with later UE address change information notify, the notification endpoint URI, and other attributes.

Step 3102: NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get to get the 5GVnGroupConfiguration of concerned 5G LAN VN. NEF gets the internal group ID, PDU session type, DNN and S-NSSAI of corresponding 5G LAN VN from 5GVnGroupConfiguration

In an embodiment, NEF finds the serving PCFs by querying NRF using DNN and S-NSSAI of corresponding 5G LAN VN. NEF subscribes the UE address change information on each discovered PCF via enhanced Npcf_EventExposure APL The Npcf_EventExposure API is described in 3GPP TS 29.523 V17.1.0, the disclosure of which is incorporated by reference herein in its entirety.

In an embodiment, if NEF gets the DNN (and optionally a corresponding S-NSSAI) information from AF, then NEF discovers the PCF(s) that serves the DN by querying NRF, using DNN and S-NSSAI as query parameter. Then NEF invokes enhanced Npcf_EventExposure API for each PCF serving the DN to subscribe and/or get the UE address change information of the DN.

Step 3103: NEF invokes enhanced Npcf_EventExposure_Subscribe to subscribe UE address change information on each concerned PCF.

Npcf_EventExposure_Subscribe operation is enhanced to:
Support new event
   Event 3-1: UE MAC address change
   Event 3-2: UE IP address change
Support a new UE ID information (e.g. SUPI) to identify the concerned UE(s)
A new existing-address indication to indicate if existing UE address information should be returned

In an embodiment, if only (existing) DNN and S-NSSAI (snssaiDnn attribute in PcEventExposureSubsc data type) exists it indicates the subscription on all UE address change of a 5G LAN VN or DN.

In an embodiment, if (existing) DNN and S-NSSAI and (new) UE ID (SUPI) exist it indicates the subscription on UE address change of a specific UE of a 5G LAN VN or DN

In an embodiment, if (existing) DNN and S-NSSAI and (existing) internal group ID (groupId attribute in PcEventExposureSubsc data type) exist it indicates the subscription on UE address change of a group of UEs for the DN

Step 3104: NEF receives the response of Npcf_EventExposure_Subscribe

The response of Npcf_EventExposure_Subscribe is enhanced, to include a new list of UE address change information, to return the existing UE address information if corresponding indication is set in Npcf_EventExposure_Subscribe.

Step 3105: NEF sends response of Nnef_EventExposure_Subscribe to AF with a list of UE address change information (if received in step 3104).

Step 3106: PCFs send UE address change notification via enhanced Npcf_EventExposure_Notify to NEF based on the UE_MAC_CH or UE_IP_CH policy control request trigger reported by SMF.

Npcf_EventExposure_Notify operation is enhanced:
EventNotification data type is enhanced to include a new list of UE address change information.

Step 3107: NEF sends response of Npcf_EventExposure_Notify to NEF.

Step 3108: NEF sends the Nnef_EventExposure_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 3109: AF sends response of Nnef_EventExposure_Notify to NEF.

In an embodiment, NEF may communicate with the serving PCF for the UE address change of a specific UE PDU session identified by UE address. NEF can interwork with the serving PCF of a specific PDU session (of a 5G LAN VN or DN) via the enhanced Npcf_PolicyAuthorization API as described in 3GPP TS 29.514 V16.7.0, the disclosure of which is incorporated by reference herein in its entirety, to monitor the UE address change information of the specific PDU session.

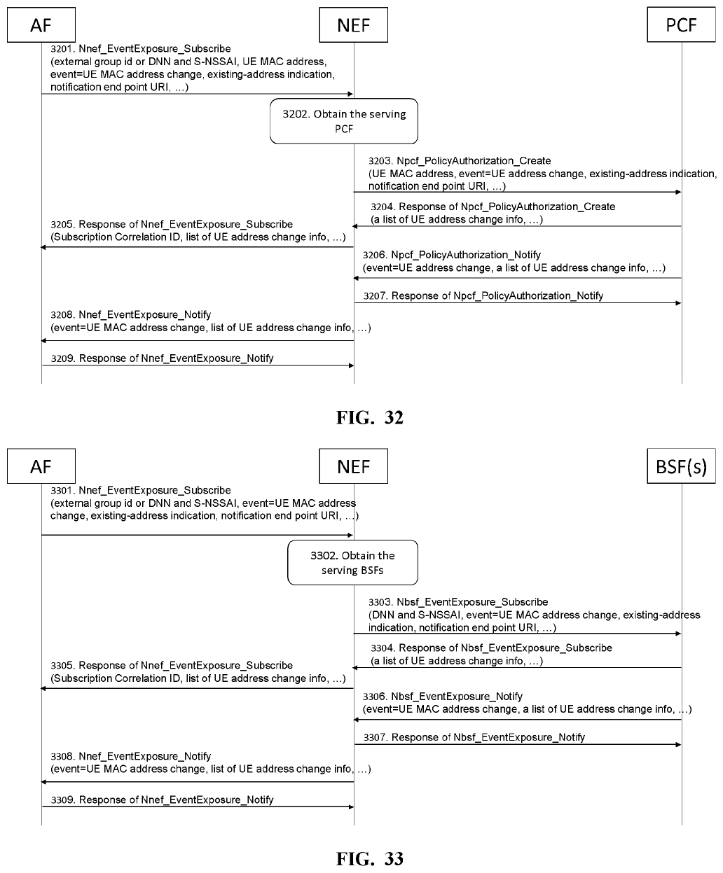

FIG. 32 shows a flowchart of AF subscribes the UE address change of a specific PDU session via an existing API and NEF collects UE address change information directly from serving PCF according to an embodiment of the present disclosure. For some parts which have been described in the above embodiments, the description thereof is omitted here for brevity.

Step 3201: AF invokes Nnef_EventExposure_Subscribe service operation via NEF to subscribe the UE address change information of a specific PDU session of a 5G LAN VN or DN. The attributes of this service operation include the external group ID of the concerned 5G LAN VN or a DNN and a S-NSSAI, the UE address of the concerned UE(s) (MAC address in this example), the event to be subscribed (e.g., UE MAC address change), an existing-address indication to indicate if existing UE address information shall be returned so AF can build a full view of the UE address information of the specific PDU session of the 5G LAN VN or DN together with later UE address change information notify, the notification endpoint URI, and other attributes.

Step 3202: NEF discovers the serving PCF of the PDU session via NRF and BSF (binding support function), by using the UE address (MAC address in this example), the DNN and S-NSSAI if need.

Step 3203: NEF invokes Npcf_PolicyAuthorization_Create/Subscribe to subscribe UE address change on the serving PCF of this specific PDU session.

Npcf_PolicyAuthorization_Create (or Npcf_PolicyAuthorization_Subscribe) is to be enhanced:
Support new event
   Event 4: UE address change (type is indicated by address itself)
A new existing-address indication to indicate if existing UE address information should be returned

Step 3204: NEF receives the response of Npcf_PolicyAuthorization_Create. The response of Npcf_PolicyAuthorization_Create is to be enhanced, to include a new list of UE address change information, to return the existing UE address information if corresponding indication is set in Npcf_PolicyAuthorization_Create.

Step 3205: NEF sends response of Nnef_EventExposure_Subscribe to AF with a list of UE address change information (if received in step 3204).

Step 3206: PCF sends Npcf_PolicyAuthorization_Notify to NEF if UE address change of this PDU session is detected.

Npcf_PolicyAuthorization_Notify operation is enhanced:
EventNotification data type is enhanced to include a new list of UE address change information.

Step 3207: NEF sends response of Npcf_PolicyAuthorization_Notify to PCF.

Step 3208: NEF sends the Nnef_EventExposure_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 3209: AF sends response of Nnef_EventExposure_Notify to NEF.

The solution of FIG. 32 is applicable for monitoring UE address change of a specific PDU session, which may related to a 5G LAN VN or a DN.

In an embodiment, NEF may communicate with BSF via a new Nbsf_EventExposure API to obtain the existing UE address information and/or UE address change information related to the network. BSF maintains the PCF session binding information wherein UE address information exists. Therefore, NEF can also get UE address change information from BSF. A new Nbsf_EventExposure API can be introduced to expose the UE address change information for a 5G LAN VN or DN (identified by DNN and S-NSSAI).

FIG. 33 shows a flowchart of AF subscribes the UE address change of a 5G LAN VN or DN via an existing API and NEF collects UE address change information from BSF(s) according to an embodiment of the present disclosure. For some parts which have been described in the above embodiments, the description thereof is omitted here for brevity.

Step 3301: AF invokes Nnef_EventExposure_Subscribe service operation via NEF to subscribe the UE address change information of a 5G LAN VN or DN. The attributes of this service operation include the external group ID of the concerned 5G LAN VN or a DNN and a S-NSSAI, the event to be subscribed (e.g., UE MAC address change), an existing-address indication to indicate if existing UE address information shall be returned so AF can build a full view of the UE address information of the 5G LAN VN or DN together with later UE address change information notify, the notification endpoint URI, and other attributes.

Step 3302: NEF discovers the UDM which hosts the corresponding 5G LAN VN configuration via NRF discovery, by using external group ID of concerned 5G LAN VN as query parameter.

In an embodiment, NEF uses the Nudm_ParameterProvision_Get to get the 5GVnGroupConfiguration of concerned 5G LAN VN. NEF gets the internal group ID, PDU session type, DNN and S-NSSAI of corresponding 5G LAN VN from 5GVnGroupConfiguration

In an embodiment, NEF discovers the BSF(s) by querying NRF using DNN and S-NSSAI of concerned 5G LAN VN as query parameters.

In an embodiment, if NEF gets the DNN and S-NSSAI information from AF, then NEF discovers the BSF(s) that serves the DN by querying NRF, using DNN and S-NSSAI as query parameters.

Step 3303: NEF invokes the new Nbsf_EventExposure_Subscribe service operation to subscribe the UE address change information of a 5G LAN VN or DN on each BSF discovered in step 3302, with information of event to be subscribed (UE MAC address change in this example), the concerned DN (identified by DNN and S-NSSAI), the existing-address indication to indicate if existing UE address information should be returned, the notification end point URI, etc.

Step 3304: NEF receives the response of Nbsf EventExposure_Subscribe, which may include a list of UE address change information, to return the existing UE address information if corresponding indication is set in Nbsf_EventExposure_Subscribe.

Step 3305: NEF sends response of Nnef_EventExposure_Subscribe to AF with a list of UE address change information (if received in step 3304).

Step 3306: BSF sends Nbsf_EventExposure_Notify to NEF if UE address change of the DN is detected. The notification includes the detected event (UE MAC address change in this example) and a list of UE address change information.

Step 3307: NEF sends response of Nbsf_EventExposure_Notify to PCF.

Step 3308: NEF sends the Nnef_EventExposure_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Step 3309: AF sends response of Nnef_EventExposure_Notify to NEF.

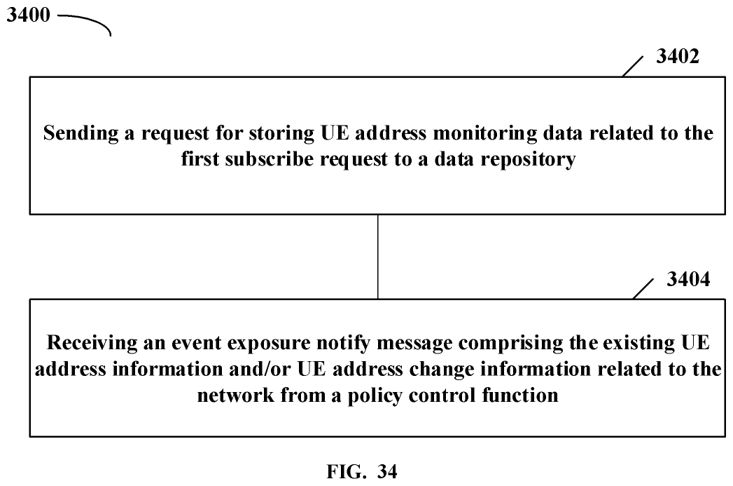

FIG. 34 shows a flowchart 3400 of obtaining the existing UE address information and/or UE address change information related to the network according to another embodiment of the present disclosure. For some parts which have been described in the above embodiments, the description thereof is omitted here for brevity.

At step 3402, the exposure function sends a request for storing UE address monitoring data related to the first subscribe request to a data repository. In an embodiment, the data repository may be UDR.

At step 3404, the exposure function receives an event exposure notify message comprising the existing UE address information and/or UE address change information related to the network from a policy control function.

For example, the policy control function such as PCF may subscribe the UE address monitoring data related to the first subscribe request on the data repository. Then policy control function may send the event exposure notify message comprising the existing UE address information and/or UE address change information related to the network to the exposure function.

In an embodiment, the NEF communicates with PCF(s) that serving PDU sessions of the 5G LAN VN or DN indirectly via UDR.

In an embodiment, the Nudr_DataRepository API as described in 3GPP TS 29.519 V17.1.0, the disclosure of which is incorporated by reference herein in its entirety, may be enhanced as below:
A new resource for new 5G UE Address monitoring data as one of Application Data (e.g., /application-data/addmonte)

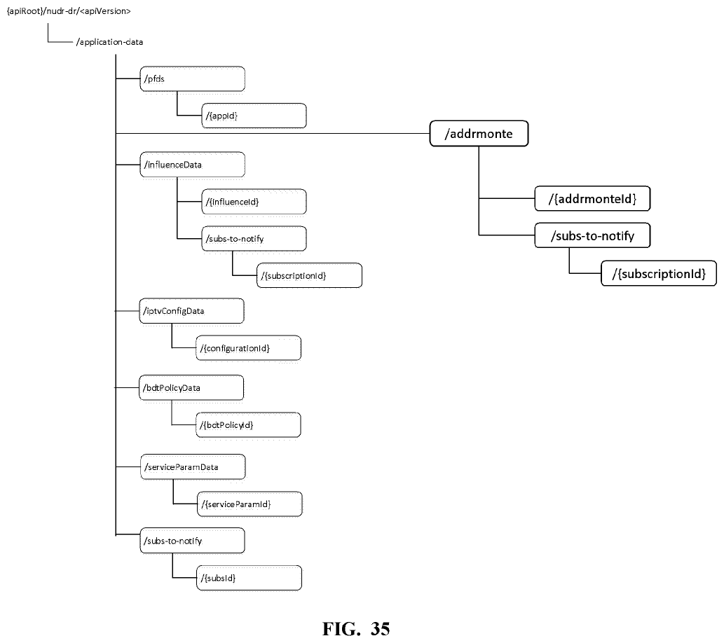

FIG. 35 shows a new resource for new 5G UE address monitoring data as one of Application Data according to an embodiment of the present disclosure. Table 1 shows resources and methods overview of FIG. 35. PFD denotes Packet Flow Description. HTTP denotes Hyper Text Transfer Protocol. IPTV denotes TV over Internet. BDT denotes Background Data Transfer.

TABLE 1
Resources and methods overview

| | | HTTP method or | |
|---|---|---|---|
| Resource name | Resource URI | custom operation | Description |
| PFD Data | /application-data/pfds | GET | Retrieve PFDs for application |
| | | | identifier(s) identified by query |
| | | | parameter(s). |
| | | | Retrieve PFDs for all application |
| | | | identifier(s) if no query parameter |
| | | | is included in the Request URI. |
| Individual PFD | /application-data/pfds/{appId} | GET | Retrieve the corresponding PFDs |
| Data | | | of the specified application |
| | | | identifier. |
| | | DELETE | Delete the corresponding PFDs |
| | | | of the specified application |
| | | | identifier. |
| | | PUT | Create or update the |
| | | | corresponding PFDs for the |
| | | | specified application identifier. |
| Influence Data | /application-data/influenceData | GET | Retrieve the Session Influence |
| | | | Data of given services, S-NSSAIs |
| | | | and DNNs or Internal Group |
| | | | Identifiers or SUPIs. |
| Individual | /application-data/influenceData/ | PUT | Create an individual Influence |
| Influence Data | {influenceId} | | Data resource identified by |
| | | | {influenceId}, or modify all of the |
| | | | properties of an individual |
| | | | Influence Data resource |
| | | | identified by {influenceId}. |
| | | PATCH | Modify part of the properties of an |
| | | | individual Influence Data |
| | | | resource identified by |
| | | | {influenceId}. |
| | | DELETE | Delete an individual Influence |
| | | | Data resource identified by |
| | | | {influenceId}. |
| Influence Data | /application-data/influenceData/ | POST | Create a new Individual Influence |
| Subscription | subs-to-notify | | Data Subscription resource. |
| | | GET | Read subscriptions for a given |
| | | | S-NSSAI and DNN or Internal |
| | | | Group Identifier or SUPI. |
| Individual | /application-data/influenceData/ | GET | Get an existing individual |
| Influence Data | subs-to-notify/ | | Influence Data Subscription |
| Subscription | {subscriptionId} | | resource identified by |
| | | | {subscriptionId}. |
| | | PUT | Modify an existing individual |
| | | | Influence Data Subscription |
| | | | resource identified by |
| | | | {subscriptionId}. |
| | | DELETE | Delete an individual Influence |
| | | | Data Subscription resource |
| | | | identified by {subscriptionId}. |
| Applied BDT | /application-data/bdtPolicyData | GET | Retrieve the applied BDT policy |
| Policy Data | | | data. |
| Individual | /application-data/bdtPolicyData/ | PUT | Create an individual applied BDT |
| Applied BDT | {bdtPolicyId} | | Policy Data resource identified by |
| Policy Data | | | {bdtPolicyId} |
| | | PATCH | Modify BDT Reference Id of an |
| | | | individual applied BDT Policy |
| | | | Data resource identified by |
| | | | {bdtPolicyId}. |
| | | DELETE | Delete an individual applied BDT |
| | | | Policy Data resource identified by |
| | | | {bdtPolicyId}. |
| IPTV | /application-data/ | GET | Retrieve IPTV configurations for |
| Configurations | iptvConfigData | | configuration identifier(s), given |
| | | | S-NSSAI(s) and DNN(s), or |
| | | | SUPIs or Internal Group |
| | | | Identifiers |
| Individual IPTV | /application-data/ | PUT | Create an |
| Configuation | iptvConfigData/ | | IndividualIptvConfiguration |
| | {configurationId} | | resource identified by |
| | | | {configurationId}, or modify all the |
| | | | properties of an Individual IPTV |
| | | | Configuration resource identified |
| | | | by {configurationId}. |
| | | PATCH | Modify some properties of an |
| | | | Individual IPTV Configuration |
| | | | resource identified by |
| | | | {configurationId}. |
| | | DELETE | Delete an Individual IPTV |
| | | | Configuration resource identified |
| | | | by {configurationId} |
| Service | /application-data/ | GET | Retrieve the Service Parameter |
| Parameter | serviceParamData | | Data of given services, S-NSSAIs |
| Data | | | and DNNs or Internal Group |
| | | | Identifiers or SUPIs. |
| Individual | /application-data/ | PUT | Create an individual Service |
| Service | serviceParamData/ | | Parameter Data resource |
| Parameter | {serviceParamId} | | identified by {serviceParamId}, or |
| Data | | | modify all of the properties of an |
| | | | individual Service Parameter |
| | | | Data resource identified by |
| | | | {serviceParamId}. |
| | | PATCH | Modify part of the properties of an |
| | | | individual Service Parameter |
| | | | Data resource identified by |
| | | | {serviceParamId}. |
| | | DELETE | Delete an individual Service |
| | | | Parameter Data resource |
| | | | identified by {serviceParamId}. |
| ApplicationDa- | /application-data/ | POST | Create a subscription to receive |
| taSubscriptions | subs-to-notify | | notification of application data |
| | | | changes. |
| | | GET | Read all the subscriptions, or |
| | | | subscriptions for given S-NSSAI |
| | | | and DNN or Internal Group |
| | | | Identifier or SUPI. |
| IndividualApplicationDa- | /application-data/ | PUT | Modify a subscription to receive |
| taSubscription | subs-to-notify/ | | notification of application data |
| | {subsId} | | changes identified by {subsId}. |
| | | DELETE | Delete a subscription identified |
| | | | by {subsId}. |
| | | GET | Read an existing individual |
| | | | Subscription resource identified |
| | | | by {subsId}. |
| UE address | /application-data/addrmonte | GET | Retrieve UE address monitoring |
| monitoring data | | | data for UE address monitoring |
| | | | data identifier(s) identified by |
| | | | query parameter(s). |
| | | | Retrieve UE address monitoring |
| | | | data for all UE address |
| | | | monitoring data identifier(s) if no |
| | | | query parameter is included in |
| | | | the Request URI. |
| Individual UE | /application-data/addrmonte/ | GET | Retrieve the corresponding UE |
| address | {addrmonteId} | | address monitoring data of the |
| monitoring data | | | specified UE address monitoring |
| | | | data identifier. |
| | | DELETE | Delete the corresponding UE |
| | | | address monitoring data of the |
| | | | specified UE address monitoring |
| | | | data identifier. |
| | | PUT | Create or update the |
| | | | corresponding UE address |
| | | | monitoring data for the specified |
| | | | UE address monitoring data |
| | | | identifier. |
| UE address | /application-data/ | POST | Create a new Individual UE |
| monitoring data | addrmonte/ | | address monitoring data |
| Subscription | subs-to-notify | | Subscription resource. |
| | | GET | Read subscriptions for DNN and |
| | | | S-NSSAI; or |
| | | | Read subscriptions for DNN and |
| | | | S-NSSAI and UE ID; or |
| | | | Read subscriptions for DNN and |
| | | | S-NSSAI and internal group ID. |
| Individual UE | /application-data/ | GET | Get an existing individual UE |
| address | addrmonte/subs-to-notify/ | | address monitoring data |
| monitoring data | {subscriptionId} | | subscription resource identified |
| Subscription | | | by {subscriptionId}. |
| | | PUT | Modify an existing individual UE |
| | | | address monitoring data |
| | | | resource identified by |
| | | | {subscriptionId}. |
| | | DELETE | Delete an individual UE address |
| | | | monitoring data Subscription |
| | | | resource identified by |
| | | | {subscriptionId}. |

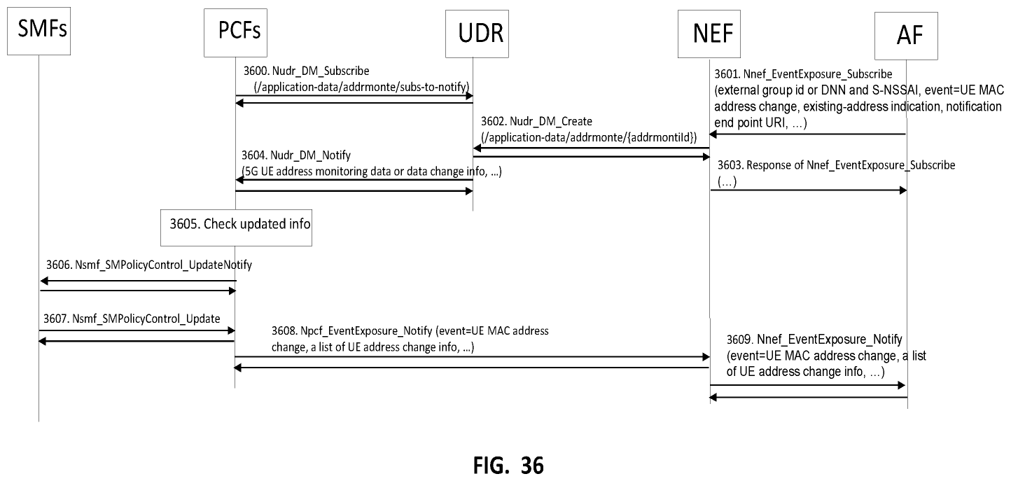

FIG. 36 shows a flowchart of AF subscribes the UE address change of a 5G LAN VN or DN via an existing API and NEF collects UE address change information indirectly from PCF(s) according to an embodiment of the present disclosure.

Step 3600: PCFs subscribe the data change of new 5G UE address monitoring data on UDR.

In one embodiment, the subscription can go via the sub resource of the new 5G UE Address monitoring data, e.g., via/application-data/addrmonte/subs-to-notify.

In another embodiment, the subscription can go via the existing /application-data/subs-to-notify

Step 3601: AF invokes Nnef_EventExposure_Subscribe service operation via NEF to subscribe the UE address change information of a 5G LAN VN or DN. The attributes of this service operation include the external group ID of the concerned 5G LAN VN or a DNN and a S-NSSAI, the event to be subscribed (e.g., UE MAC address change), an existing-address indication to indicate if existing UE address information shall be returned so AF can build a full view of the UE address information of the 5G LAN VN or DN together with later UE address change information notify, the notification endpoint URI, and other attributes.

Step 3602: NEF via enhanced Nudr_DataRepository API stores a new 5G UE address monitoring data into UDR (e.g., under/application-data/addrmonte/{addrmonteld}), as one new Application Data. 5G UE address monitoring data includes following information:
UE ID (e.g. SUPI)
Internal group ID

If only DNN and S-NSSAI exists it indicates the subscription on all UE address change of a 5G LAN VN or DN. If DNN and S-NSSAI and UE ID exist it indicates the subscription on UE address change of a specific UE of a 5G LAN VN or DN. If DNN and S-NSSAI and internal group ID exist it indicates the subscription on UE address change of a group of UEs for a DN.
DNN and S-NSSAI of concerned 5G LAN VN or DN
PDU session type
An existing-address indication indicating if existing UE address information should be returned
Notification endpoint URI
Notification correlation ID
Reporting control information (e.g. frequency, etc.)
Reporting filter (e.g. filtered by UE address change type, IP ranges, MAC ranges, UE ID ranges)

Step 3603: NEF sends response of Nnef_EventExposure_Subscribe to AF.

Step 3604: PCFs that have subscribed the new 5G UE address monitoring data change will be notified by UDR on the change of 5G UE address monitoring data.

Step 3605 and step 3606:

PCFs determine if they need to monitor the 5G UE address change by checking if they are responsible for the DNN and S-NSSAI indicated by the 5G UE address monitoring data.

According to the PDU session type in 5G UE address monitoring data, PCFs apply (existing) UE_MAC_CH or (existing) UE_IP_CH policy control request trigger (if not before) for ongoing and future PDU sessions related to DNN and S-NSSAI.

If the indication of returning existing UE address information (existing-address indication) is set, the PCFs also report the existing UE address information via enhanced Npcf_EventExposure_Notify (see the solution of FIG. 31).

Step 3607 and 3608: PCFs send UE address change notification via enhanced Npcf_EventExposure_Notify (see the solution of FIG. 31) to NEF based on the UE_MAC_CH or UE_IP_CH policy control request trigger reported by SMF.

Step 3609: NEF sends the Nnef_EventExposure_Notify service operation to the notification endpoint URI in the subscription service operation with the event ID (UE MAC address change), a list of UE address change information and other attributes to AF. Each UE address change information contains the UE ID (e.g., GPSI or SUPI) of the concerned UE(s), and a list of UE address information wherein the UE address(es) and UE address change type (new address, obsoleted address or existing address) are indicated.

Since the data in UDR is normally static or semi-static data, it is not suitable to store the dynamic UE PDU session address as part of 5G UE address monitoring data in UDR. Therefore, the use case of monitoring UE address change for a specific UE PDU session is not supported.

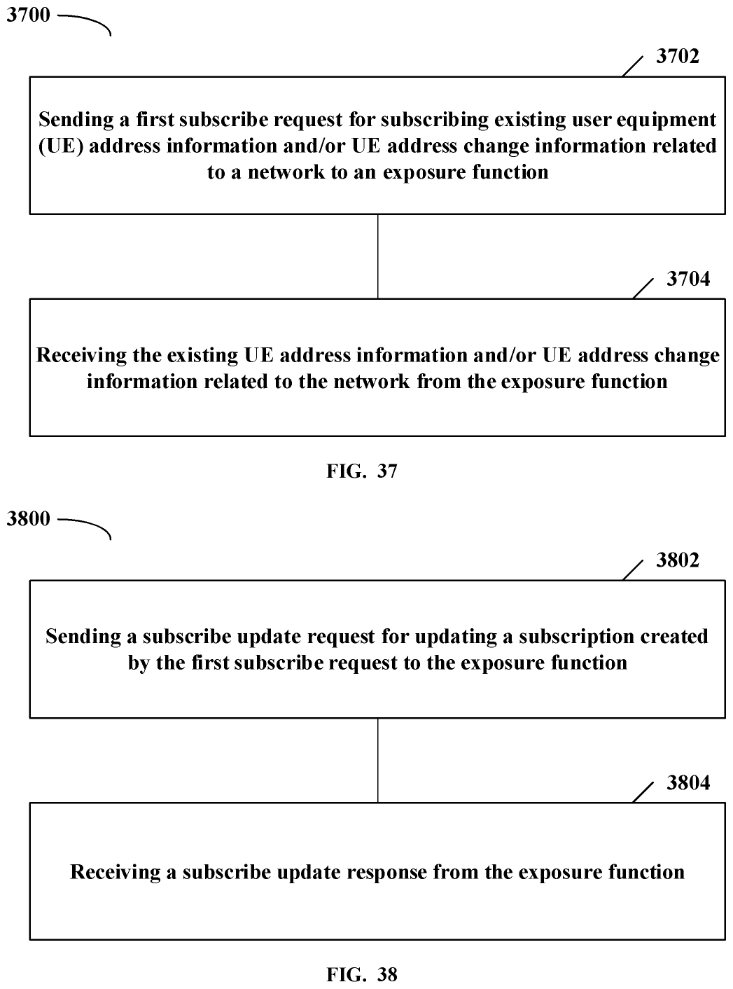

FIG. 37 shows a flowchart of a method according to another embodiment of the present disclosure, which may be performed by an apparatus implemented in or at or as an application function or communicatively coupled to the application function. As such, the apparatus may provide means or modules for accomplishing various parts of the method 3700 as well as means or modules for accomplishing other processes in conjunction with other components. For some parts which have been described in the above embodiments, the description thereof is omitted here for brevity.

At block 3702, the application function sends a first subscribe request for subscribing existing user equipment (UE) address information and/or UE address change information related to a network to an exposure function.

At block 3704, the application function receives the existing UE address information and/or UE address change information related to the network from the exposure function.

In an embodiment, the existing UE address information is received in a first subscribe response or at least one UE address notification message.

In an embodiment, the UE address change information is received in at least one UE address notification message.

FIG. 38 shows a flowchart of a method according to another embodiment of the present disclosure, which may be performed by an apparatus implemented in or at or as an application function or communicatively coupled to the application function. As such, the apparatus may provide means or modules for accomplishing various parts of the method 3800 as well as means or modules for accomplishing other processes in conjunction with other components. For some parts which have been described in the above embodiments, the description thereof is omitted here for brevity.

At block 3802, the application function sends a subscribe update request for updating a subscription created by the first subscribe request to the exposure function.

At block 3804, the application function receives a subscribe update response from the exposure function.

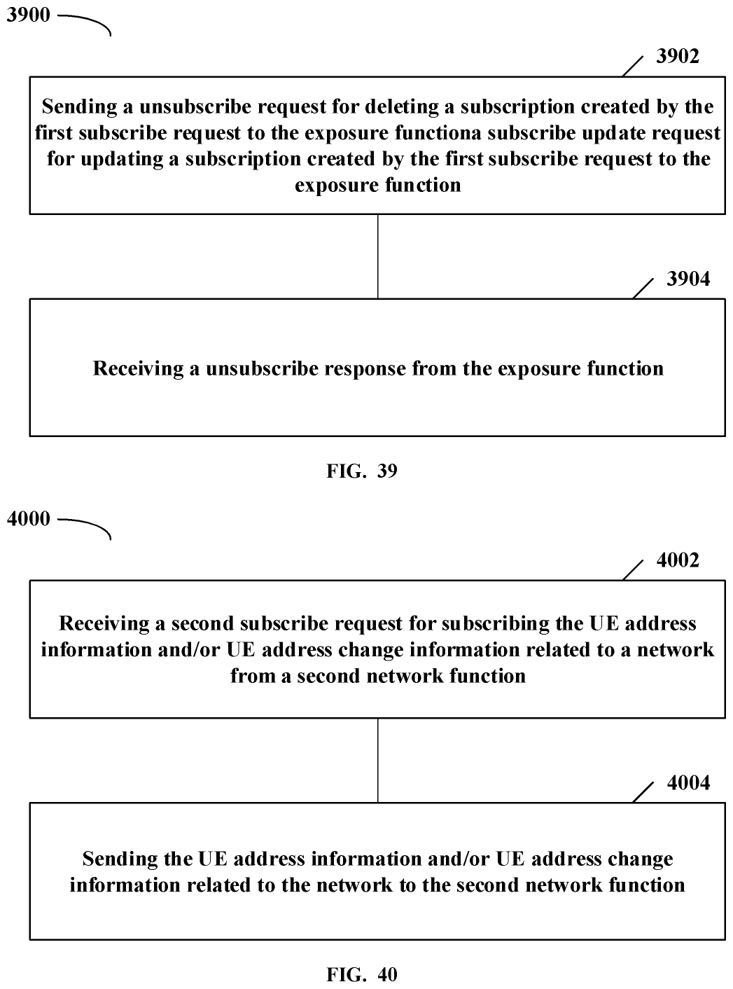

FIG. 39 shows a flowchart of a method according to another embodiment of the present disclosure, which may be performed by an apparatus implemented in or at or as an application function or communicatively coupled to the application function. As such, the apparatus may provide means or modules for accomplishing various parts of the method 3900 as well as means or modules for accomplishing other processes in conjunction with other components. For some parts which have been described in the above embodiments, the description thereof is omitted here for brevity.

At block 3902, the application function sends a unsubscribe request for deleting a subscription created by the first subscribe request to the exposure function.

At block 3904, the application function receives a unsubscribe response from the exposure function.

FIG. 40 shows a flowchart of a method according to another embodiment of the present disclosure, which may be performed by an apparatus implemented in or at or as a first network function or communicatively coupled to the first network function. As such, the apparatus may provide means or modules for accomplishing various parts of the method 4000 as well as means or modules for accomplishing other processes in conjunction with other components. For some parts which have been described in the above embodiments, the description thereof is omitted here for brevity.

At block 4002, the first network function receives a second subscribe request for subscribing the UE address information and/or UE address change information related to a network from a second network function.

In an embodiment, the first network function comprises at least one of a session management function, a binding support function, or a policy control function.

In an embodiment, the second network function is an exposure function or a network data analytics function (NWDAF).

In an embodiment, the second network function comprises at least one of Service Capability Exposure Function (SCEF), Network Exposure Function (NEF), SCEF combined with NEF, or network data analytics function (NWDAF).

In an embodiment, the second subscribe request comprises an identifier of the network.

In an embodiment, the second subscribe request comprises an identifier of the network and a UE identifier.

In an embodiment, the second subscribe request comprises an identifier of the network and an address of a UE.

In an embodiment, the second subscribe request comprises an identifier of the network and a group identifier.

In an embodiment, the second subscribe request comprises at least one of single network slice selection assistance information (S-NSSAI), an indication of UE MAC address change event to be subscribed, an indication of UE IP address change event to be subscribed, an indication of whether existing UE address information shall be returned, a uniform resource identifier (URI) of a notification endpoint, reporting control information, a reporting filter.

At block 4004, the first network function sends the UE address information and/or UE address change information related to the network to the second network function.

In an embodiment, the existing UE address information is sent in a second subscribe response or at least one event exposure notification message.

In an embodiment, the UE address change information is sent in at least one event exposure notification message.

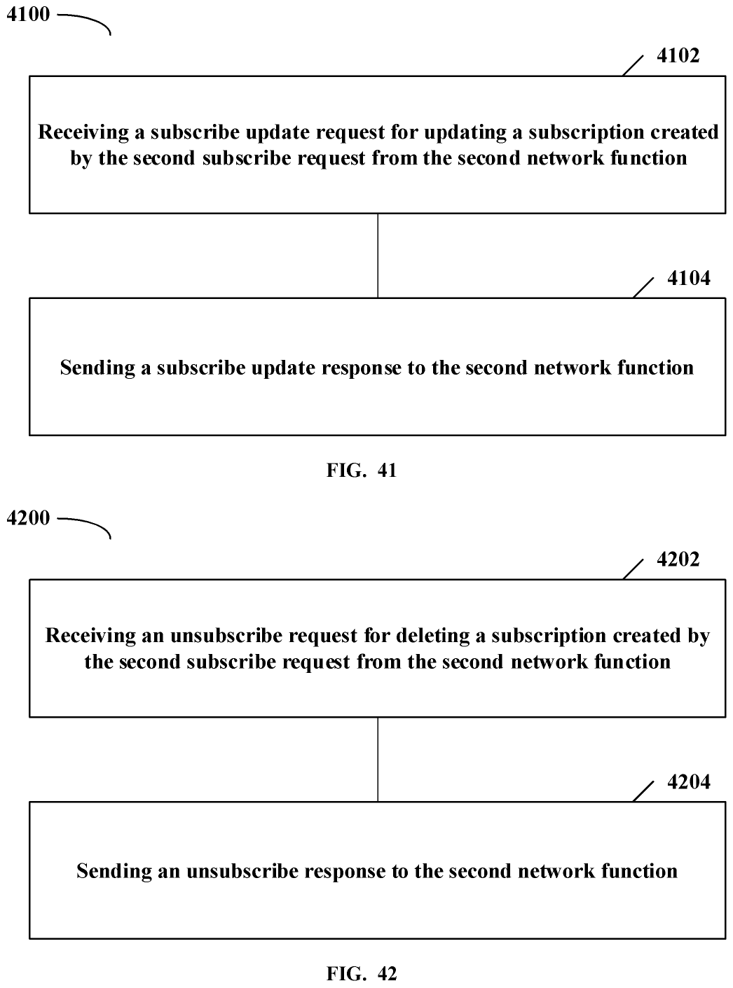

FIG. 41 shows a flowchart of a method according to another embodiment of the present disclosure, which may be performed by an apparatus implemented in or at or as a first network function or communicatively coupled to the first network function. As such, the apparatus may provide means or modules for accomplishing various parts of the method 4100 as well as means or modules for accomplishing other processes in conjunction with other components. For some parts which have been described in the above embodiments, the description thereof is omitted here for brevity.

At block 4102, the first network function receives a subscribe update request for updating a subscription created by the second subscribe request from the second network function.

At block 4104, the first network function sends a subscribe update response to the second network function.

FIG. 42 shows a flowchart of a method according to another embodiment of the present disclosure, which may be performed by an apparatus implemented in or at or as a first network function or communicatively coupled to the first network function. As such, the apparatus may provide means or modules for accomplishing various parts of the method 4200 as well as means or modules for accomplishing other processes in conjunction with other components. For some parts which have been described in the above embodiments, the description thereof is omitted here for brevity.

At block 4202, the first network function receives an unsubscribe request for deleting a subscription created by the second subscribe request from the second network function.

At block 4204, the first network function sends an unsubscribe response to the second network function.

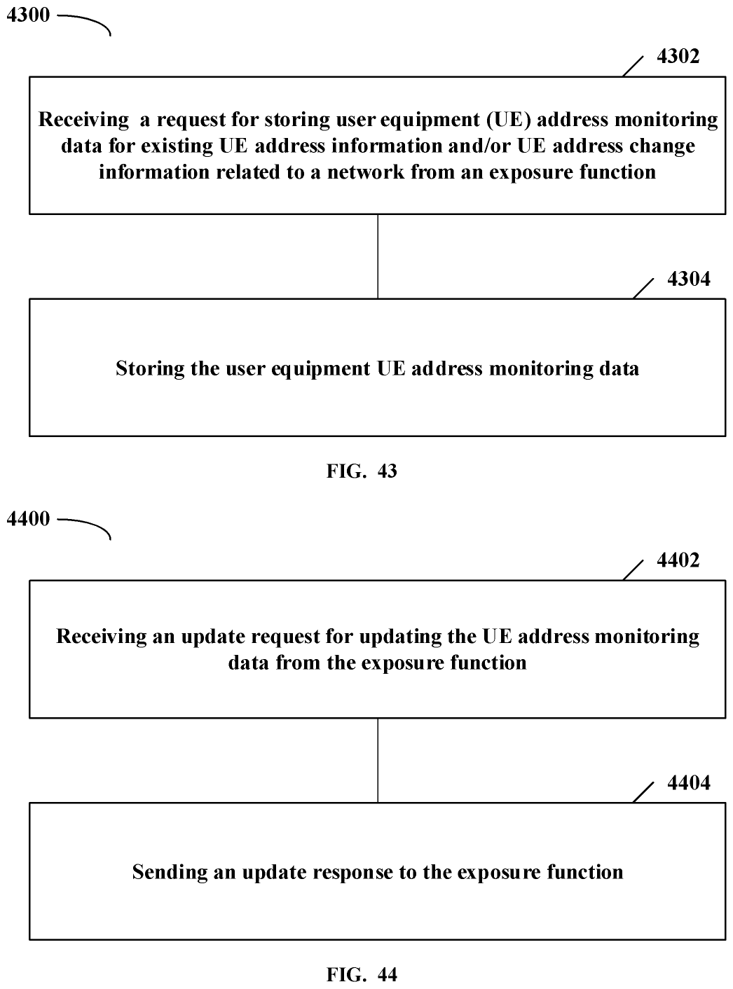

FIG. 43 shows a flowchart of a method according to another embodiment of the present disclosure, which may be performed by an apparatus implemented in or at or as a data repository or communicatively coupled to the data repository. As such, the apparatus may provide means or modules for accomplishing various parts of the method 4300 as well as means or modules for accomplishing other processes in conjunction with other components. For some parts which have been described in the above embodiments, the description thereof is omitted here for brevity.

At block 4302, the data repository receives a request for storing user equipment (UE) address monitoring data for existing UE address information and/or UE address change information related to a network from an exposure function. The data repository may be UDR.

At block 4304, the data repository stores the UE address monitoring data. The user equipment UE address monitoring data may be subscribed by any other suitable network functions.

In an embodiment, the UE address monitoring data comprises an identifier of the network.

In an embodiment, the UE address monitoring data comprises an identifier of the network and a UE identifier.

In an embodiment, the UE address monitoring data comprises an identifier of the network and an address of a UE.

In an embodiment, the UE address monitoring data comprises an identifier of the network and a group identifier.

In an embodiment, the UE address monitoring data comprises at least one of single network slice selection assistance information (S-NSSAI), an indication of UE MAC address change event to be subscribed, an indication of UE IP address change event to be subscribed, an indication of whether existing UE address information shall be returned, a uniform resource identifier (URI) of a notification endpoint, reporting control information, a reporting filter.

In an embodiment, the reporting control information comprises periodic reporting interval.

In an embodiment, the reporting filter comprises at least one of a UE address change type, an IP range, an MAC range, or a UE identifier range.

In an embodiment, the UE address change type comprises at least one of a type of new UE address, a type of obsoleted UE address, or a type of existing UE address.

FIG. 44 shows a flowchart of a method according to another embodiment of the present disclosure, which may be performed by an apparatus implemented in or at or as a data repository or communicatively coupled to the data repository. As such, the apparatus may provide means or modules for accomplishing various parts of the method 4400 as well as means or modules for accomplishing other processes in conjunction with other components. For some parts which have been described in the above embodiments, the description thereof is omitted here for brevity.

At block 4402, the data repository receives an update request for updating the UE address monitoring data from the exposure function.

At block 4404, the data repository sends an update response to the exposure function.

The data repository may perform an update operation and generate a update operation execution result indication. The update response may comprise an update operation execution result indication.

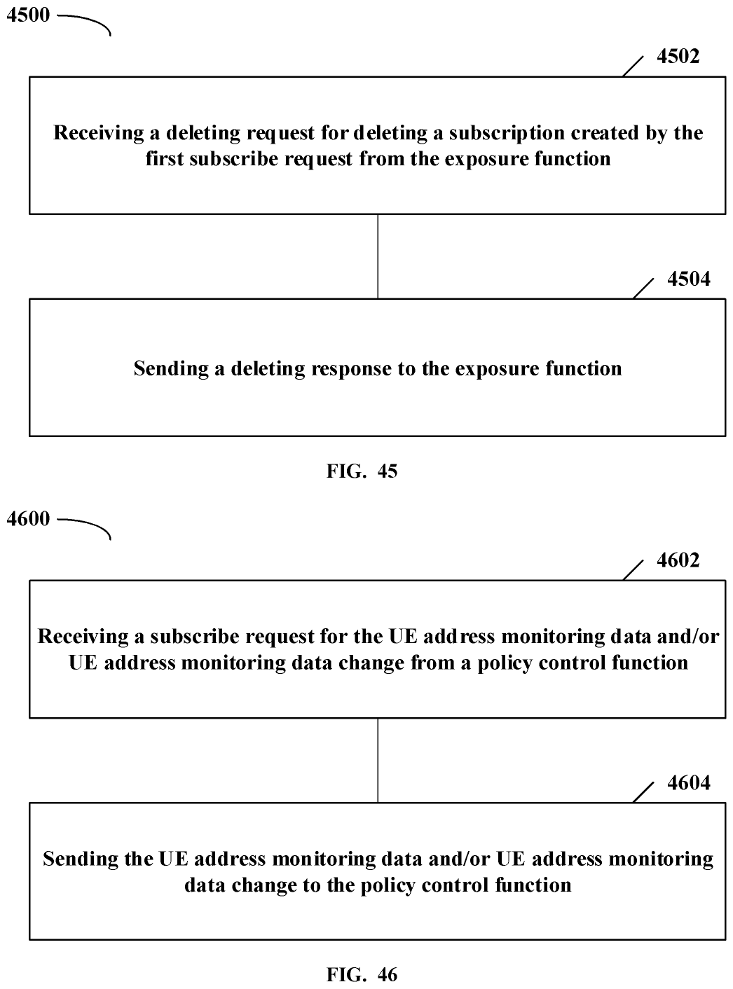

FIG. 45 shows a flowchart of a method according to another embodiment of the present disclosure, which may be performed by an apparatus implemented in or at or as a data repository or communicatively coupled to the data repository. As such, the apparatus may provide means or modules for accomplishing various parts of the method 4500 as well as means or modules for accomplishing other processes in conjunction with other components. For some parts which have been described in the above embodiments, the description thereof is omitted here for brevity.

At block 4502, the data repository receives a deleting request for deleting a subscription created by the first subscribe request from the exposure function.

At block 4504, the data repository sends a deleting response to the exposure function.

The data repository may perform a deleting operation and generate a deleting operation execution result indication. The deleting response may comprise a deleting operation execution result indication.

FIG. 46 shows a flowchart of a method according to another embodiment of the present disclosure, which may be performed by an apparatus implemented in or at or as a data repository or communicatively coupled to the data repository. As such, the apparatus may provide means or modules for accomplishing various parts of the method 4600 as well as means or modules for accomplishing other processes in conjunction with other components. For some parts which have been described in the above embodiments, the description thereof is omitted here for brevity.

At block 4602, the data repository receives a subscribe request for the UE address monitoring data and/or UE address monitoring data change from a policy control function.

At block 4604, the data repository sends the UE address monitoring data and/or UE address monitoring data change to the policy control function.

In an embodiment, the UE address monitoring data and/or UE address monitoring data change is sent in a subscribe response or a notify message.

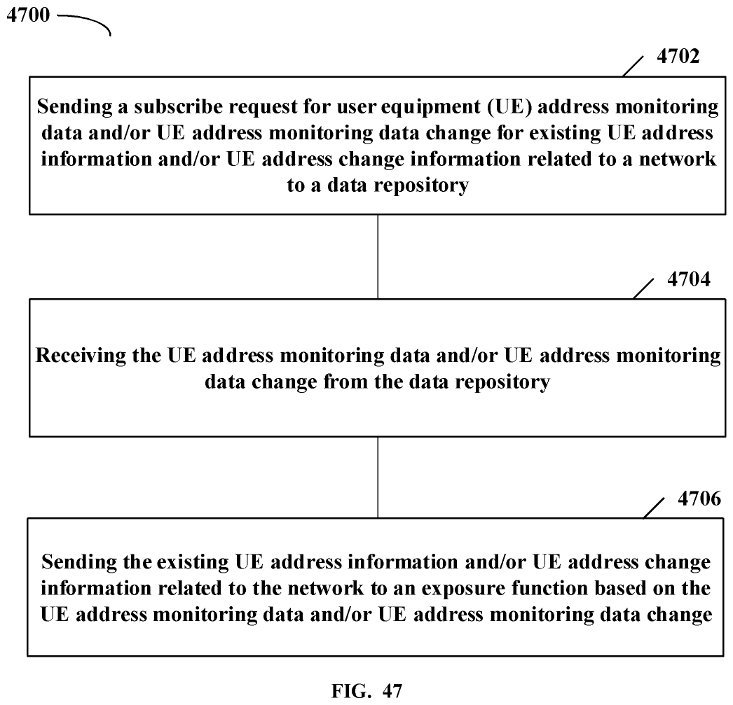

FIG. 47 shows a flowchart of a method according to another embodiment of the present disclosure, which may be performed by an apparatus implemented in or at or as a policy control function or communicatively coupled to the policy control function. As such, the apparatus may provide means or modules for accomplishing various parts of the method 4700 as well as means or modules for accomplishing other processes in conjunction with other components. For some parts which have been described in the above embodiments, the description thereof is omitted here for brevity.

At block 4702, the policy control function sends a subscribe request for user equipment (UE) address monitoring data and/or UE address monitoring data change for existing UE address information and/or UE address change information related to a network to a data repository.

At block 4704, the policy control function receives the UE address monitoring data and/or UE address monitoring data change from the data repository.

At block 4706, the policy control function sends the existing UE address information and/or UE address change information related to the network to an exposure function based on the UE address monitoring data and/or UE address monitoring data change.

In an embodiment, the UE address monitoring data and/or UE address monitoring data change is received in a subscribe response or a notify message.

In an embodiment, the UE address (change) information can comprise at least one of existing UE address information (info) and/or UE address change of a 5G LAN VN or a DN; existing UE address information and/or UE address change of a UE of a 5G LAN VN or a DN; existing UE address information and/or UE address change of a PDU session of a 5G LAN VN or a DN; or existing UE address information and/or UE address change of a group of UE for a DN

According to various embodiments, two solutions are provided. Solution #1—expose UE address (change) information to AF via a new NEF API. Solution #2—expose UE address (change) information to AF via an existing NEF API with enhancements, e.g., via the existing Nnef_EventExposure API.

According to various embodiments, there is provided new methods of collecting UE address (change) information of a 5G LAN VN or a DN from 5GC NFs, for UE address (change) information exposure or analytic. Multiple following solutions are provided.

Solution #3—NEF gets the UE address (change) information of a 5G LAN VN or a DN from the SMF(s), via the existing Nsmf_EventExposure API with enhancements.

Solution #4—NEF gets the UE address (change) information from PCF(s) that serve the PDU sessions of the 5G LAN VN or DN

Solution #4.1—NEF communicates with PCFs indirectly via UDR

NEF via enhanced Nudr_DataRepository API stores a new 5G UE address monitoring data into UDR, as one new Application Data. PCFs that have subscribed the change of new 5G UE address monitoring data will be notified by UDR on the change of 5G UE address monitoring data. PCFs monitor the UE address change on SMF(s) via the UE_MAC_CH and/or UE_IP_CH policy control request trigger. PCFs send UE address change notification via enhanced Npcf_EventExposure_Notify to NEF based on the UE_MAC_CH and/or UE_IP_CH policy control request trigger reported by SMF(s).

Solution #4.2—NEF communicates with PCFs directly via enhanced Npcf_EventExposure API.

NEF finds the PCFs by querying NRF using DNN and S-NSSAI of corresponding 5G LAN VN or DN, and directly communicates with PCFs by using enhanced Npcf_EventExposure API.

Solution #4.3—NEF communicates with the serving PCF for the UE address change of a specific UE PDU session identified by UE address.

NEF communicates with the serving PCF of a specific PDU session by using enhanced Npcf_PolicyAuthorization API.

Solution #5—NEF gets the UE address (change) information from BSF(s) via a new Nbsf_EventExposure API.

According to various embodiments, UE address (change) information of a 5G LAN VN is valuable data asset of VN user and Mobile Network Operators (MNOs), for Operator's traffic and/or charging policy for VN usage, VN usage operation and maintenance, data analytic for VN usage optimization, or as triggers for further actions at AF side.

According to various embodiments, there is provided new methods of exposing UE address (change) information of a 5G LAN VN via NEF, to facilitate AF to monitor UE address (change) information of a 5G LAN VN for various purpose, in terms of existing UE address information and/or UE address change of a 5G LAN VN, existing UE address information and/or UE address change of a UE of a 5G LAN VN; existing UE address information and/or UE address change of a PDU session of a 5G LAN VN; or existing UE address information and/or UE address change of a group of UEs of a DN

According to various embodiments, there is provided new methods of collecting UE address (change) information of a 5G LAN VN from 5GC NFs, for UE address (change) information exposure or analytic. These methods are in general applicable for collecting UE PDU session information for exposure or analytic, e.g. by introducing new event(s) for PDU session information (and information change).

The methods according to various embodiments are also applicable for monitoring/collecting UE address (change) information for UE(s) that are related to a DN. The methods according to various embodiments can be used with combinations or independently.

Embodiments herein may provide many advantages, of which a non-exhaustive list of examples follows. In some embodiments herein, the proposed solution can enable a device such as application function to get the UE address (change) information of a network such as 5G LAN VN or a DN via an exposure function (e.g., NEF). In some embodiments herein, the proposed solution can enable an exposure function (e.g., NEF) to get the UE address (change) information of a network such as a 5G LAN VN or a DN from other network function(s) such as 5GC NFs. The embodiments herein are not limited to the features and advantages mentioned above. A person skilled in the art will recognize additional features and advantages upon reading the following detailed description.

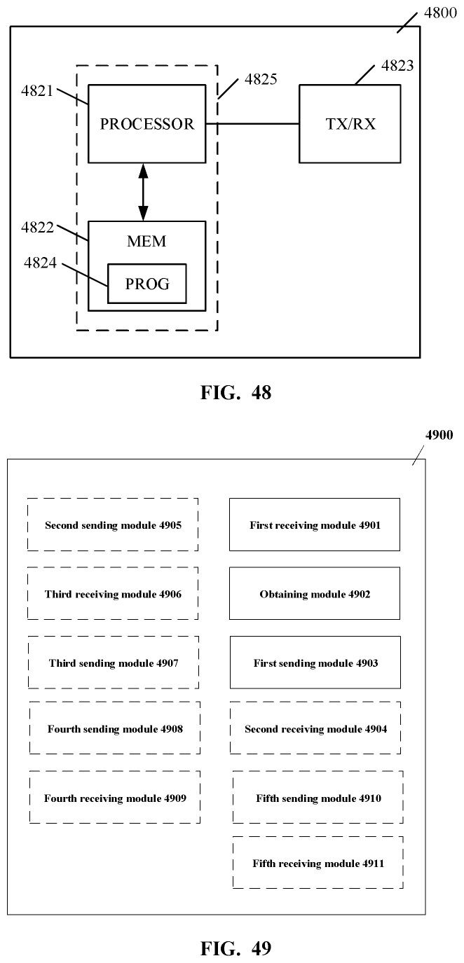

FIG. 48 is a block diagram showing an apparatus suitable for practicing some embodiments of the disclosure. For example, any one of the exposure function, the application function, the first network function, the data repository, or the policy control function described above may be implemented as or through the apparatus 4800.

The apparatus 4800 comprises at least one processor 4821, such as a digital processor (DP), and at least one memory (MEM) 4822 coupled to the processor 4821. The apparatus 4800 may further comprise a transmitter TX and receiver RX 4823 coupled to the processor 4821. The MEM 4822 stores a program (PROG) 4824. The PROG 4824 may include instructions that, when executed on the associated processor 4821, enable the apparatus 4800 to operate in accordance with the embodiments of the present disclosure. A combination of the at least one processor 4821 and the at least one MEM 4822 may form processing means 4825 adapted to implement various embodiments of the present disclosure.

Various embodiments of the present disclosure may be implemented by computer program executable by one or more of the processor 4821, software, firmware, hardware or in a combination thereof.

The MEM 4822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 4821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the exposure function, the memory 4822 contains instructions executable by the processor 4821, whereby the exposure function operates according to any of the methods related to the exposure function as described above.

In an embodiment where the apparatus is implemented as or at the application function, the memory 4822 contains instructions executable by the processor 4821, whereby the application function operates according to any of the methods related to the application function as described above.

In an embodiment where the apparatus is implemented as or at the first network function, the memory 4822 contains instructions executable by the processor 4821, whereby the first network function operates according to any of the methods related to the first network function as described above.

In an embodiment where the apparatus is implemented as or at the data repository, the memory 4822 contains instructions executable by the processor 4821, whereby the data repository operates according to any of the methods related to the data repository as described above.

In an embodiment where the apparatus is implemented as or at the policy control function, the memory 4822 contains instructions executable by the processor 4821, whereby the policy control function operates according to any of the methods related to the policy control function as described above.

FIG. 49 is a block diagram showing an exposure function according to an embodiment of the disclosure. As shown, the exposure function 4900 comprises a first receiving module 4901, an obtaining module 4902 and a first sending module 4903. The first receiving module 4901 may be configured to receive a first subscribe request for subscribing existing user equipment (UE) address information and/or UE address change information related to a network from an application function. The obtaining module 4902 may be configured to obtain the existing UE address information and/or UE address change information related to the network based on the first subscribe request. The sending module 4903 may be configured to send the existing UE address information and/or UE address change information related to the network to the application function.

In an embodiment, the exposure function 4900 may further comprise a second receiving module 4904 configured to receive a subscribe update request for updating a subscription created by the first subscribe request from the application function.

In an embodiment, the exposure function 4900 may further comprise a second sending module 4905 configured to send a subscribe update response to the application function.

In an embodiment, the exposure function 4900 may further comprise a third receiving module 4906 configured to receive an unsubscribe request for deleting a subscription created by the first subscribe request from the application function.

In an embodiment, the exposure function 4900 may further comprise a third sending module 4907 configured to send an unsubscribe response to the application function.

In an embodiment, the exposure function 4900 may further comprise a fourth sending module 4908 configured to send a subscribe update request for updating a subscription created by the second subscribe request to the first network function.

In an embodiment, the exposure function 4900 may further comprise a fourth receiving module 4909 configured to receive a subscribe update response from the first network function.

In an embodiment, the exposure function 4900 may further comprise a fifth sending module 4910 configured to send an unsubscribe request for deleting a subscription created by the second subscribe request to the first network function.

In an embodiment, the exposure function 4900 may further comprise a fifth receiving module 4911 configured to receive an unsubscribe response from the first network function.

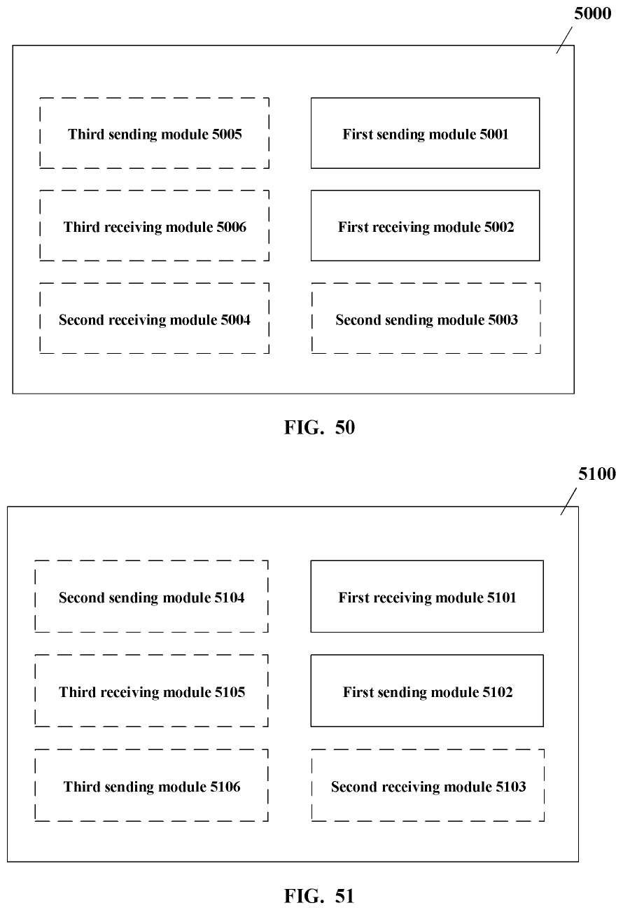

FIG. 50 is a block diagram showing an application function according to an embodiment of the disclosure. As shown, the application function 5000 comprises a first sending module 5001 and a first receiving module 5002. The first sending module 5001 may be configured to send a first subscribe request for subscribing existing user equipment (UE) address information and/or UE address change information related to a network to an exposure function. The first receiving module 5002 may be configured to receive the existing UE address information and/or UE address change information related to the network from the exposure function.

In an embodiment, the application function 5000 may further comprise a second sending module 5003 configured to send a subscribe update request for updating a subscription created by the first subscribe request to the exposure function.

In an embodiment, the application function 5000 may further comprise a second receiving module 5004 configured to receive a subscribe update response from the exposure function.

In an embodiment, the application function 5000 may further comprise a third sending module 5005 configured to send a unsubscribe request for deleting a subscription created by the first subscribe request to the exposure function.

In an embodiment, the application function 5000 may further comprise a third receiving module 5006 configured to receive a unsubscribe response from the exposure function.

FIG. 51 is a block diagram showing a first network function according to an embodiment of the disclosure. As shown, the first network function 5100 comprises a first receiving module 5101 and a first sending module 5102. The first receiving module 5101 may be configured to receive a second subscribe request for subscribing the UE address information and/or UE address change information related to a network from a second network function. The first sending module 5102 may be configured to send the UE address information and/or UE address change information related to the network to the second network function.

In an embodiment, the first network function 5100 may further comprise a second receiving module 5103 and a second sending module 5104. The second receiving module 5103 may be configured to receive a subscribe update request for updating a subscription created by the second subscribe request from the second network function. The second sending module 5104 may be configured to send a subscribe update response to the second network function.

In an embodiment, the first network function 5100 may further comprise a third receiving module 5105 and a third sending module 5106. The first receiving module 5105 may be configured to receive an unsubscribe request for deleting a subscription created by the second subscribe request from the second network function. The first sending module 5106 may be configured to send an unsubscribe response to the second network function.

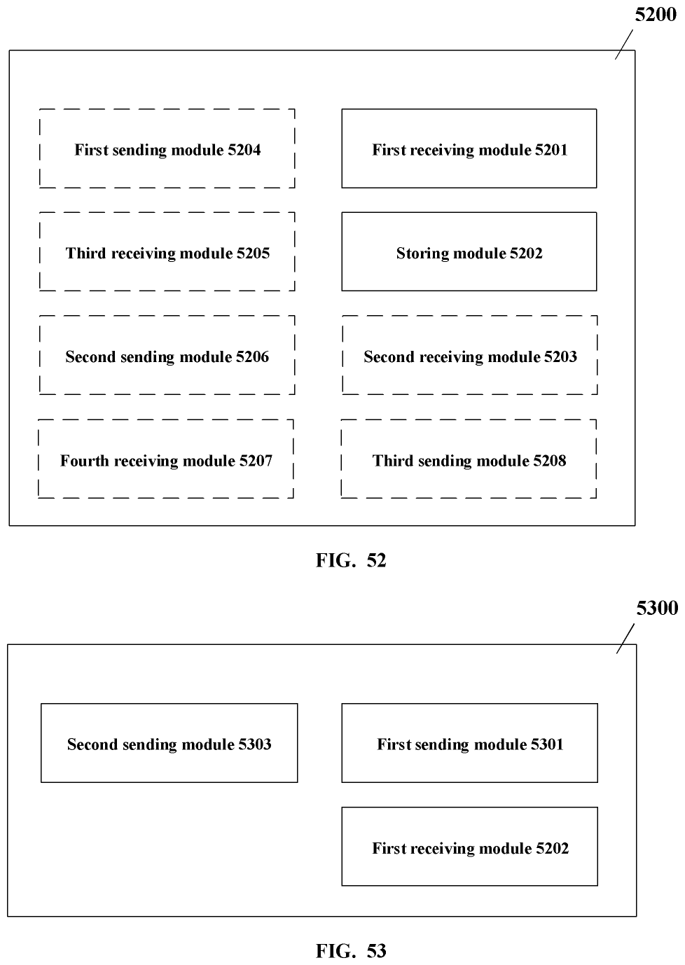

FIG. 52 is a block diagram showing a data repository according to an embodiment of the disclosure. As shown, the data repository 5200 comprises a first receiving module 5201 and a storing module 5202. The first receiving module 5101 may be configured to receive a request for storing user equipment (UE) address monitoring data for existing UE address information and/or UE address change information related to a network from an exposure function. The storing module 5202 may be configured to store the user equipment UE address monitoring data.

In an embodiment, the data repository 5200 may further comprise a second receiving module 5203 and a first sending module 5204. The second receiving module 5203 may be configured to receive an update request for updating the UE address monitoring data from the exposure function. The first sending module 5204 may be configured to send an update response to the exposure function.

In an embodiment, the data repository 5200 may further comprise a third receiving module 5205 and a second sending module 5206. The third receiving module 5205 may be configured to receive a deleting request for deleting a subscription created by the first subscribe request from the exposure function. The second sending module 5206 may be configured to send a deleting response to the exposure function.

In an embodiment, the data repository 5200 may further comprise a fourth receiving module 5207 and a third sending module 5208. The fourth receiving module 5207 may be configured to receive a subscribe request for the UE address monitoring data and/or UE address monitoring data change from a policy control function. The third sending module 5208 may be configured to send the UE address monitoring data and/or UE address monitoring data change to the policy control function.

FIG. 53 is a block diagram showing a policy control function according to an embodiment of the disclosure. As shown, the policy control function 5300 comprises a first sending module 5301, a first receiving module 5202 and a second sending module 5303. The first sending module 5301 may be configured to send a subscribe request for user equipment (UE) address monitoring data and/or UE address monitoring data change for existing UE address information and/or UE address change information related to a network to a data repository. The first receiving module 5202 may be configured to receive the UE address monitoring data and/or UE address monitoring data change from the data repository. The second sending module 5303 may be configured to send the existing UE address information and/or UE address change information related to the network to an exposure function based on the UE address monitoring data and/or UE address monitoring data change.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the exposure function, the application function, the first network function, the data repository, or the policy control function may not need a fixed processor or memory, any computing resource and storage resource may be arranged from the exposure function, the application function, the first network function, the data repository, or the policy control function in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-101. (canceled)

102. A method performed by an exposure function of a communication network, the method comprising:
receiving, from an application function of the communication network, a first subscribe request for existing user equipment (UE) address information and/or UE address change information related to a network;
obtaining the existing UE address information and/or UE address change information related to the network, in accordance with the first subscribe request; and
sending to the application function the obtained existing UE address information and/or UE address change information related to the network.

103. The method according to claim 102, wherein the obtained existing UE address information and/or UE address change information related to the network, is further related to one or more of the following: a specific UE in the network, a specific UE protocol data unit (PDU) session in the network, and a specific group of UEs in the network.

104. The method according to claim 102, wherein the network comprises at least one of the following: a local area network (LAN) virtual network; and a data network.

105. The method according to claim 102, wherein the obtained existing UE address information includes at least one of the following:
an Internet Protocol (IP) address being used by the UE;
a Medium Access Control (MAC) address being used by the UE;
an IP address being used by at least one device connected to the UE; or
a MAC address being used by at least one device connected to the UE.

106. The method according to claim 102, wherein the first subscribe request includes one of the following: an identifier of the network; an identifier of the network and a UE identifier; or an identifier of the network and a group identifier.

107. The method according to claim 102, wherein the first subscribe request includes at least one of the following:
single network slice selection assistance information (S-NSSAI),
an indication of UE medium access control (MAC) address change event to be subscribed,
an indication of UE Internet Protocol (IP) address change event to be subscribed,
an indication of whether existing UE address information shall be returned,
a uniform resource identifier (URI) of a notification endpoint,
reporting control information, and
a reporting filter.

108. The method according to claim 102, wherein when the existing UE address information is obtained, the existing UE address information is sent to the application function in a first subscribe response or in at least one UE address notification message.

109. The method according to claim 102, wherein when the UE address change information is obtained, the UE address change information is sent to the application function in at least one UE address notification message.

110. The method according to claim 102, wherein the exposure function is one of the following: a Service Capability Exposure Function (SCEF), a Network Exposure Function (NEF), or a combined SCEF and NEF.

111. A method performed by an application function of a communication network, the method comprising:
sending, to an exposure function of the communication network, a first subscribe request for existing user equipment (UE) address information and/or UE address change information related to a network; and
receiving from the exposure function the existing UE address information and/or UE address change information related to the network, in accordance with the first subscribe request.

112. The method according to claim 111, wherein the received existing UE address information and/or UE address change information related to the network, is further related to one or more of the following: a specific UE in the network, a specific UE protocol data unit (PDU) session in the network, and a specific group of UEs in the network.

113. The method according to claim 111, the network comprises at least one of the following: a local area network (LAN) virtual network, and a data network.

114. The method according to claim 111, wherein the existing UE address information includes at least one of the following:
an Internet Protocol (IP) address being used by the UE;
a Medium Access Control (MAC) address being used by the UE;
an IP address being used by at least one device connected to the UE; or
a MAC address being used by at least one device connected to the UE.

115. The method according to claim 111, wherein the first subscribe request includes one of the following: an identifier of the network; an identifier of the network and a UE identifier; or an identifier of the network and a group identifier.

116. The method according to claim 111, wherein the first subscribe request includes at least one of the following:
single network slice selection assistance information (S-NSSAI),
an indication of UE medium access control (MAC) address change event to be subscribed,
an indication of UE Internet Protocol (IP) address change event to be subscribed,
an indication of whether existing UE address information shall be returned,
a uniform resource identifier (URI) of a notification endpoint,
reporting control information, and
a reporting filter.

117. The method according to claim 111, wherein when the existing UE address information is received from the exposure function, the existing UE address information is received in a first subscribe response or in at least one UE address notification message.

118. The method according to claim 111, wherein when the UE address change information is received from the exposure function, the UE address change information is received in at least one UE address notification message.

119. The method according to claim 111, wherein the exposure function is one of the following: a Service Capability Exposure Function (SCEF), a Network Exposure Function (NEF), or a combined SCEF and NEF.

120. An exposure function configured to operate in a communication network, the exposure function comprising:
a processor; and
a memory coupled to the processor, said memory containing instructions executable by said processor, whereby the exposure function is operative to:
receive, from an application function of the communication network, a first subscribe request for existing user equipment (UE) address information and/or UE address change information related to a network;
obtain the existing UE address information and/or UE address change information related to the network in accordance with the first subscribe request; and
send to the application function the obtained existing UE address information and/or UE address change information related to the network.

121. An application function configured to operate in a communication network, the application function comprising:
a processor; and
a memory coupled to the processor, said memory containing instructions executable by said processor, whereby the application function is operative to:
send, to an exposure function of the communication network, a first subscribe request for existing user equipment (UE) address information and/or UE address change information related to a network; and
receive from the exposure function the existing UE address information and/or UE address change information related to the network, in accordance with the first subscribe request.
